(19) United States
(12) Patent Application Publication
(10) Pub. No.: US 2025/0119949 A1
(43) Pub. Date: Apr. 10, 2025

(54) ELECTRONIC DEVICE FOR DETERMINING ACKNOWLEDGEMENT MESSAGE TRANSMISSION POLICY OF LINK AND OPERATION METHOD OF ELECTRONIC DEVICE

(71) Applicant: SAMSUNG ELECTRONICS CO., LTD., Suwon-si (KR)

(72) Inventors: Jusik YUN, Suwon-si (KR); Junsu CHOI, Suwon-si (KR); Wonbin PARK, Suwon-si (KR); Changmok YANG, Suwon-si (KR); Junhak LIM, Suwon-si (KR); Hyeonu CHOI, Suwon-si (KR)

(21) Appl. No.: 18/948,316

(22) Filed: Nov. 14, 2024

Related U.S. Application Data
(63) Continuation of application No. PCT/KR2024/015225, filed on Oct. 7, 2024.

(30) Foreign Application Priority Data
Oct. 10, 2023 (KR) 10-2023-0134243
Dec. 13, 2023 (KR) 10-2023-0180603

(51) Int. Cl. H04W 74/0816; H04L 5/00; H04W 74/08

(52) U.S. Cl. CPC H04W 74/0816; H04L 5/0053; H04W 74/0875

(57) ABSTRACT

An electronic device may include a communication circuit configured to transmit and/or receive data via multiple links, a processor, and a memory, comprising stored instructions configured to cause the electronic device to identify whether data satisfying a designated condition is configured to be transmitted to and/or received from an external electronic device via a second link while the external electronic device is operating in a non-simultaneous transmit and receive mode, in which the external electronic device fails to receive data via the second link while transmitting data via a first link, in a case that the data satisfying the designated condition is configured transmitted to or from the external electronic device, determine an acknowledgement message transmission policy of the first link based on whether data is being transmitted to the external electronic device via the second link when transmitting data to the external electronic device via the first link.

### CROSS-REFERENCE TO RELATED APPLICATIONS

This application is a continuation application of International Application No. PCT/KR2024/015225 designating the United States, filed on Oct. 7, 2024, in the Korean Intellectual Property Office and claiming priority to Korean Patent Application No. 10-2023-0134243, filed on Oct. 10, 2023, in the Korean Intellectual Property Office; and Korean Patent Application Number 10-2023-0180603, filed on Dec. 13, 2023, in the Korean Intellectual Property Office. The disclosures of each of these applications are incorporated by reference herein in their entireties.

### TECHNICAL FIELD

Various Embodiments incorporating features of the present disclosure relate to electronic devices and methods of operating the electronic device and, more specifically to, electronic devices for determining a policy for transmitting an acknowledgement message of a link established between an external electronic device and the electronic device.

### BACKGROUND

With the increased supply of various electronic devices, improvements have been made in the corresponding speed of wireless communications utilizing the various electronic devices. Among the wireless communications supported by recent electronic devices, IEE 802.11 WLAN (or Wi-Fi) is a standard for implementing high-speed wireless connections on various electronic devices. Although the first implemented Wi-Fi could support transmission speeds of up to 1 to 9 Mbps, Wi-Fi 6 technology (or IEEE 802.11 ax) may support transmission speeds of up to about 10 Gbps.

Electronic devices may support various services using relatively high-capacity data (e.g., UHD-quality video streaming services, augmented reality (AR) services, virtual reality (VR) services, or mixed reality (MR) services) via wireless communications that support higher data rates.

The IEEE 802.11 WLAN standard plans to introduce technologies that support multi-link operation (MLO) to improve the speed of data transmission and reception and reduce latency. Electronic devices that support multi-link operation are expected to be able to transmit and receive data through multiple links, thereby achieving relatively high transmission speeds and low latency.

The electronic device may transmit data to an external electronic device via a specific link and receive an acknowledgement message from the external electronic device. The acknowledgement message may refer to a message indicating that data reception is completed. Upon receiving the acknowledgement message, the electronic device may identify that the data transmission is successful and may transmit or receive other data to or from the external electronic device.

### DISCLOSURE

An electronic device incorporating features of the present disclosure may determine (or select) a policy for transmission of an acknowledgement message through negotiation with an external electronic device.

The policy for transmission of an acknowledgement message may include a first acknowledgement message transmission mode, in which an electronic device that has received data, transmits an acknowledgement message when the electronic device has completed receiving of the data and has received an acknowledgement message transmission request, which is a message requesting transmission of the acknowledgement message, from an electronic device that has transmitted data. The first acknowledgement message transmission mode may be referred to as a delayed block acknowledgement (ack) message mode, and an acknowledgement message exchanged via the first acknowledgement message transmission mode may be referred to as a delayed block ack.

The acknowledgement message transmission policy may include a second acknowledgement message transmission mode, in which the electronic device that has received data has completed receiving of the data and then transmits the acknowledgement message after a designated time (e.g., short inter frame space (SIFS)). The second acknowledgement message transmission mode may be referred to as an immediate block ack message mode, and the acknowledgement message exchanged via the second acknowledgement message transmission mode may be referred to as an immediate block ack.

An external electronic device may operate in a non-simultaneous transmit and receive (NSTR) mode in which the external electronic device, while transmitting data through one link, fails to receive data through the other link. When the external electronic device operates in the NSTR mode, data transmission may not be possible according to the transmission policy of the acknowledgement message.

For example, an external electronic device operating in the NSTR mode may not be able to receive data through the other link while transmitting an acknowledgement message through one link, and the performance of transmitting and/or receiving data through the other link may be degraded. The degradation of data transmission and/or reception performance may degrade the quality of services using the data.

The technical tasks to be achieved in this document are not limited to the technical tasks mentioned above, and other technical tasks not mentioned may be clearly understood by a person skilled in the art to which this disclosure belongs from the following description.

An electronic device according to an embodiment may include a communication circuit configured to transmit and/or receive data via multiple links, including a first link and a second link, the multiple links being established between the electronic device and an external electronic device. The electronic device may include a processor. The electronic device may include a memory. The memory may store instructions which, when executed by the processor, cause the electronic device to identify whether data satisfying a designated condition is configured to be transmitted and/or received from the external electronic device via the second link while the external electronic device is operating in a NSTR mode, in which the external electronic device fails to receive data via the second link while transmitting data via the first link. The memory may store instructions for, in a case that the data satisfying the designated condition is configured to be transmitted to and/or received from the external electronic device via the second link, determining an acknowledgement message transmission policy of the first link based on whether data is being transmitted to the external electronic device via the second link when transmitting data to the external electronic device via the first link. The memory may store instructions for controlling the communication circuit to transmit information indicating the determined acknowledgement message transmission policy to the external electronic device.

An operation method of an electronic device according to an embodiment may include an operation of, while an external electronic device for performing communication with the electronic device via a first link and/or a second link is operating in a NSTR mode, in which the external electronic device fails to receive data via the second link while transmitting data via the first link, identifying whether data satisfying a designated condition is configured to be transmitted to and/or received from the external electronic device via the second link. The operation method of the electronic device may include an operation of, in a case that the data satisfying the designated condition is configured to be transmitted to and/or received from the external electronic device via the second link, determining an acknowledgement message transmission policy of the first link based on whether data is being transmitted to the external electronic device via the second link when transmitting data to the external electronic device via the first link. The operation method of the electronic device may include an operation of transmitting information indicating the determined acknowledgement message transmission policy to the external electronic device.

### ADVANTAGEOUS EFFECTS

In an electronic device and an operation method of the electronic device according to an embodiment, a policy for transmitting an acknowledgement message via a first link established between an external electronic device and the electronic device may be determined based on whether data satisfying a designated condition is transmitted via the second link. The electronic device may, in a case that the data satisfying the designated condition is configured to be transmitted and/or received via the second link, determine a policy of transmitting an acknowledgement message of the first link based on whether data is transmitted via the second link. Specifically, the electronic device may, in a case that data is not being transmitted via the second link, determine a policy for transmitting an acknowledgement message of the first link as a policy for transmitting the acknowledgement message upon reception of an acknowledgement message transmission request message. The electronic device may prevent (or reduce) an increase in latency of data transmission and/or reception by determining the policy for transmitting the acknowledgement message so that the external electronic device does not interfere with the reception of data via the other link by transmitting the acknowledgement message.

The effects that are obtainable from the disclosure are not limited to the effects mentioned above, and other effects not mentioned can be clearly understood by those skilled in the art to which the disclosure belongs, from the descriptions below.

### BRIEF DESCRIPTION OF DRAWINGS

FIG. 1 is a block diagram of an electronic device according to an embodiment.

FIG. 2 is a block diagram of a program according to an embodiment.

FIG. 3A illustrates an embodiment in which an electronic device and an access point (AP) operate in a multi-link operation (MLO), according to an embodiment.

FIG. 3B illustrates an embodiment in which an electronic device operates in a NSTR mode.

FIG. 3C illustrates an embodiment in which an electronic device according to an embodiment operates in an enhanced multi-link with single radio (EMLSR) mode.

FIG. 4A illustrates an example in which an electronic device according to an embodiment operates in a first acknowledgement message transmission mode.

FIG. 4B illustrates an example in which an electronic device according to an embodiment operates in a second acknowledgement message transmission mode.

FIG. 5 is a block diagram of an electronic device according to an embodiment.

FIG. 6 illustrates an example in which an electronic device according to an embodiment operates in a first acknowledgement message transmission mode based on whether data is transmitted via a second link.

FIG. 7 illustrates an example in which an electronic device according to an embodiment operates in a second acknowledgement message transmission mode based on whether data is transmitted via a second link.

FIGS. 8A and 8B illustrate an example in which an electronic device according to an embodiment operates in either a first acknowledgement message transmission mode or a second acknowledgement message transmission mode based on a data transmission loss rate that may occur when operating in a specific transmission mode.

FIG. 9 is an operation flowchart illustrating an operation method of operating an electronic device according to an embodiment.

FIG. 10 is an operation flowchart illustrating an operation method of an electronic device according to an embodiment.

### DETAILED DESCRIPTION

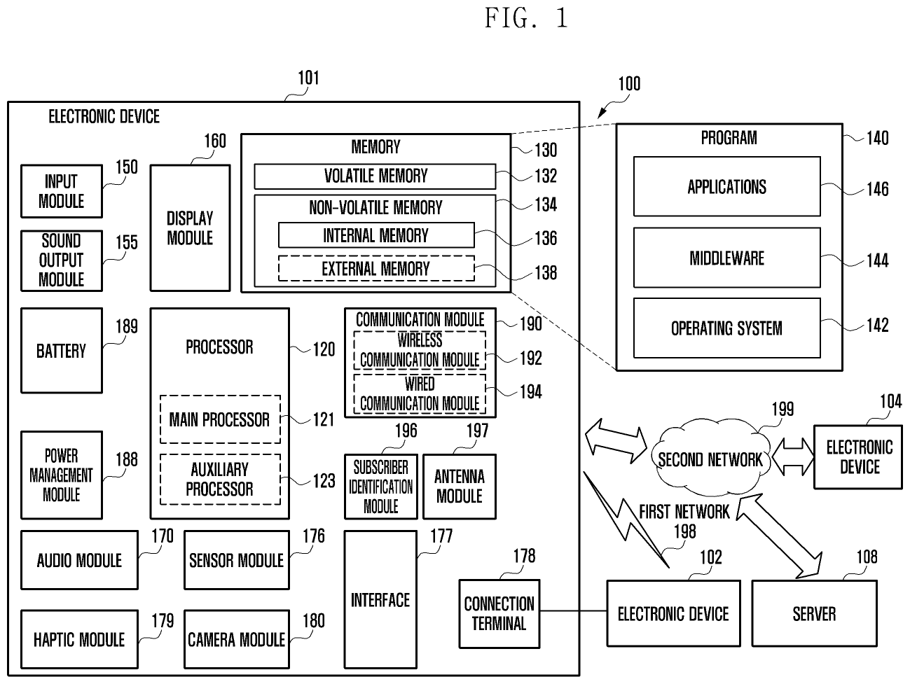

FIG. 1 is a block diagram illustrating an electronic device 101 in a network environment 100 according to various embodiments. Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

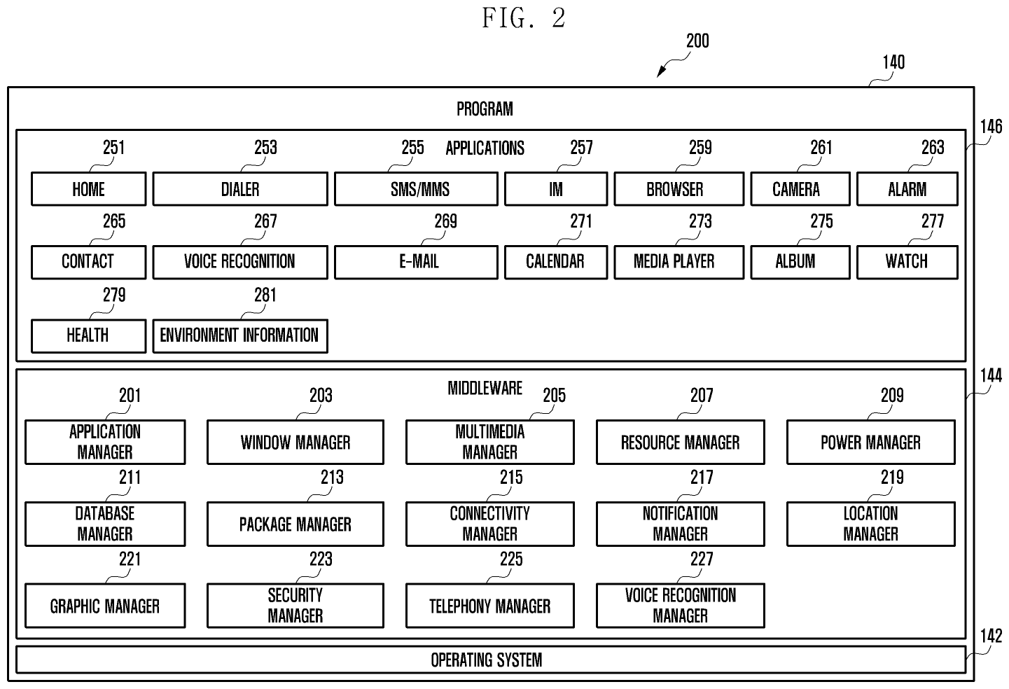

FIG. 2 is a block diagram 200 illustrating the program 140 according to various embodiments. According to an embodiment, the program 140 may include an operating system (OS) 142 to control one or more resources of the electronic device 101, middleware 144, or an application 146 executable in the OS 142. The OS 142 may include, for example, Android™, iOS™, Windows™, Symbian™, Tizen™, or Bada™. At least part of the program 140, for example, may be pre-loaded on the electronic device 101 during manufacture, or may be downloaded from or updated by an external electronic device (e.g., the electronic device 102 or 104, or the server 108) during use by a user.

The OS 142 may control management (e.g., allocating or deallocation) of one or more system resources (e.g., process, memory, or power source) of the electronic device 101. The OS 142, additionally or alternatively, may include one or more driver programs to drive other hardware devices of the electronic device 101, for example, the input module 150, the sound output module 155, the display module 160, the audio module 170, the sensor module 176, the interface 177, the haptic module 179, the camera module 180, the power management module 188, the battery 189, the communication module 190, the subscriber identification module 196, or the antenna module 197.

The middleware 144 may provide various functions to the application 146 such that a function or information provided from one or more resources of the electronic device 101 may be used by the application 146. The middleware 144 may include, for example, an application manager 201, a window manager 203, a multimedia manager 205, a resource manager 207, a power manager 209, a database manager 211, a package manager 213, a connectivity manager 215, a notification manager 217, a location manager 219, a graphic manager 221, a security manager 223, a telephony manager 225, or a voice recognition manager 227.

The application manager 201, for example, may manage the life cycle of the application 146. The window manager 203, for example, may manage one or more graphical user interface (GUI) resources that are used on a screen. The multimedia manager 205, for example, may identify one or more formats to be used to play media files, and may encode or decode a corresponding one of the media files using a codec appropriate for a corresponding format selected from the one or more formats. The resource manager 207, for example, may manage the source code of the application 146 or a memory space of the memory 130. The power manager 209, for example, may manage the capacity, temperature, or power of the battery 189, and determine or provide related information to be used for the operation of the electronic device 101 based at least in part on corresponding information of the capacity, temperature, or power of the battery 189. According to an embodiment, the power manager 209 may interwork with a basic input/output system (BIOS) (not shown) of the electronic device 101.

The database manager 211, for example, may generate, search, or change a database to be used by the application 146. The package manager 213, for example, may manage installation or update of an application that is distributed in the form of a package file. The connectivity manager 215, for example, may manage a wireless connection or a direct connection between the electronic device 101 and the external electronic device. The notification manager 217, for example, may provide a function to notify a user of an occurrence of a specified event (e.g., an incoming call, message, or alert). The location manager 219, for example, may manage locational information on the electronic device 101. The graphic manager 221, for example, may manage one or more graphic effects to be offered to a user or a user interface related to the one or more graphic effects.

The security manager 223, for example, may provide system security or user authentication. The telephony manager 225, for example, may manage a voice call function or a video call function provided by the electronic device 101. The voice recognition manager 227, for example, may transmit a user's voice data to the server 108, and receive, from the server 108, a command corresponding to a function to be executed on the electronic device 101 based at least in part on the voice data, or text data converted based at least in part on the voice data. According to an embodiment, the middleware 244 may dynamically delete some existing components or add new components. According to an embodiment, at least part of the middleware 144 may be included as part of the OS 142 or may be implemented as another software separate from the OS 142.

The application 146 may include, for example, a home 251, dialer 253, short message service (SMS)/multimedia messaging service (MMS) 255, instant message (IM) 257, browser 259, camera 261, alarm 263, contact 265, voice recognition 267, email 269, calendar 271, media player 273, album 275, watch 277, health 279 (e.g., for measuring the degree of workout or biometric information, such as blood sugar), or environmental information 281 (e.g., for measuring air pressure, humidity, or temperature information) application. According to an embodiment, the application 146 may further include an information exchanging application (not shown) that is capable of supporting information exchange between the electronic device 101 and the external electronic device. The information exchange application, for example, may include a notification relay application adapted to transfer designated information (e.g., a call, message, or alert) to the external electronic device or a device management application adapted to manage the external electronic device. The notification relay application may transfer notification information corresponding to an occurrence of a specified event (e.g., receipt of an email) at another application (e.g., the email application 269) of the electronic device 101 to the external electronic device. Additionally or alternatively, the notification relay application may receive notification information from the external electronic device and provide the notification information to a user of the electronic device 101.

The device management application may control the power (e.g., turn-on or turn-off) or the function (e.g., adjustment of brightness, resolution, or focus) of the external electronic device or some component thereof (e.g., a display module or a camera module of the external electronic device). The device management application, additionally or alternatively, may support installation, delete, or update of an application running on the external electronic device.

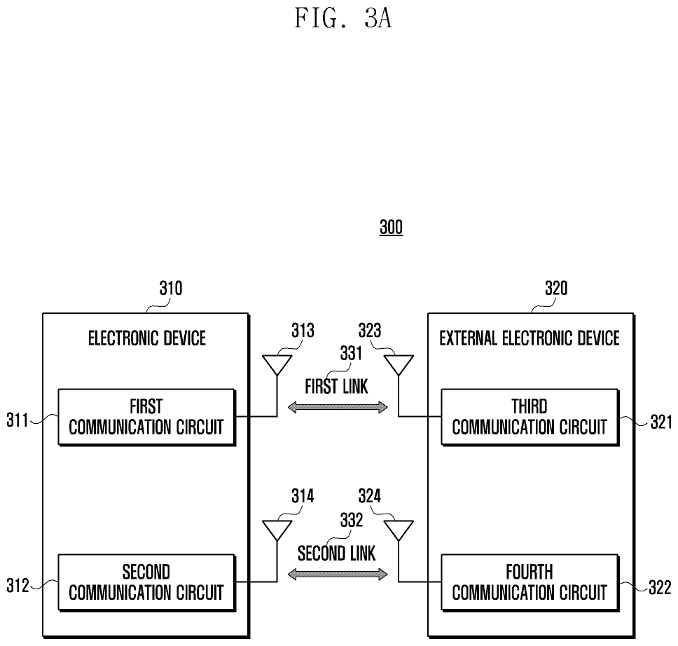

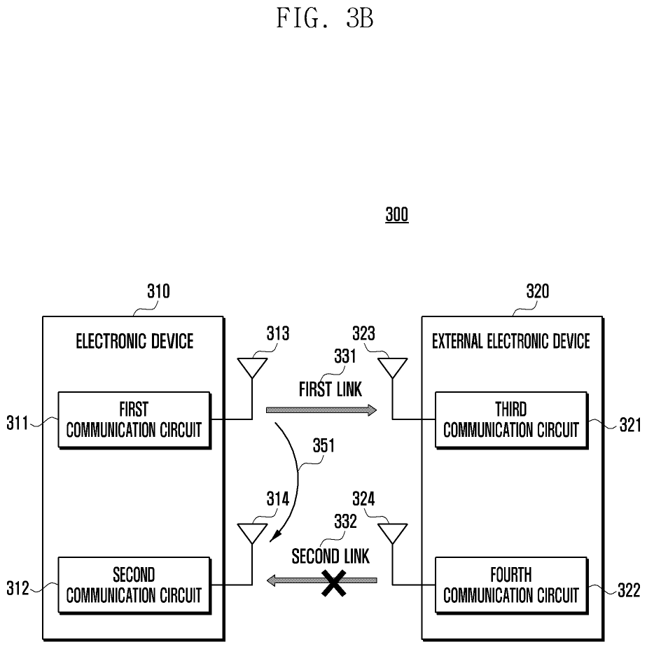

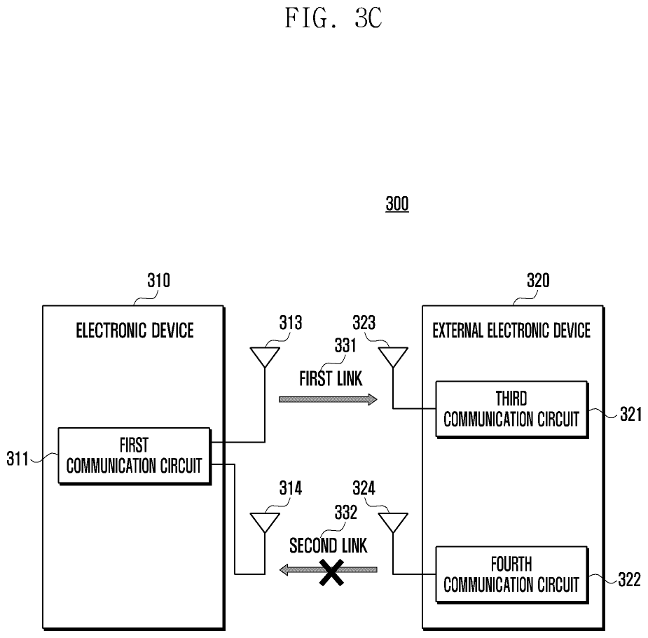

FIG. 3A illustrates an embodiment in which an electronic device and an access point (AP) operate in a multi-link operation (MLO), according to an embodiment.

Referring to FIG. 3A, a wireless LAN system 300 may include an electronic device 310 and/or an external electronic device 320. According to an embodiment, the electronic device 310 may perform wireless communication with the external electronic device 320 via short-range wireless communication. Wireless communication may refer to a variety of communication methods that may be supported by both the electronic device 310 and/or the external electronic device 320. For example, the wireless communication may be Wi-Fi. The external electronic device 320 may serve as a base station providing wireless communication to at least one electronic device 310 located within a communication radius of the wireless LAN system 300. According to an embodiment, the external electronic device 320 may include an access point (AP) of IEEE 802.11. The electronic device 310 may include a station (STA) of IEEE 802.11.

According to an embodiment, the electronic device 310 and/or the external electronic device 320 may support multi-link operation (MLO). The multi-link operation may be an operation mode in which data is transmitted or received through multiple links (e.g., a first link 331 and a second link 332). The multi-link operation may be an operation mode which is planned to be introduced in IEEE 802.11be and in which data is transmitted or received through multiple links based on multiple bands or channels.

According to an embodiment, the electronic device 310 may include multiple communication circuits (e.g., a first communication circuit 311 and/or a second communication circuit 312) to support multi-link operation. The first communication circuit 311 may transmit data to the external electronic device 320 via the first link 331, or may receive data transmitted from the external electronic device 320 via the first link 331. The first communication circuit 311 may output or receive a signal of a frequency band corresponding to the first link 331 via a first antenna 313. The second communication circuit 312 may transmit data to the external electronic device 320 via the second link 332, or may receive data transmitted from the external electronic device 320 via the second link 332. The second communication circuit 312 may output or receive a signal of a frequency band corresponding to the second link 332 via a second antenna 314.

According to an embodiment, the external electronic device 320 may include multiple communication circuits (e.g., a third communication circuit 321 and/or a fourth communication circuit 322) to support multi-link operation. The third communication circuit 321 may transmit data to the electronic device 310 via the first link 331, or may receive data transmitted from the electronic device 310 via the first link 331. The third communication circuit 321 may output or receive a signal of a frequency band corresponding to the first link 331 via a third antenna 323. The fourth communication circuit 322 may transmit data to the electronic device 310 via the second link 332, or may receive data transmitted from the electronic device 310 via the second link 332. The fourth communication circuit 322 may output or receive a signal of a frequency band corresponding to the second link 332 via a fourth antenna 324.

According to an embodiment, the frequency band of the first link 331 and the frequency band of the second link 332 may be different. For example, the frequency band of the first link 331 may be 2.5 GHz, and the frequency band of the second link 332 may be 5 GHz or 6 GHz. Alternatively, the frequency band of the first link 331 and the frequency band of the second link 332 may be the same as each other, but the channel number of the first link 331 and the channel number of the second link 332 may be different. For example, the first link 331 may be channel #1 of a 2.4 GHz frequency band, and the second link 332 may be channel #12 of a 2.4 GHz frequency band.

FIG. 3B illustrates an embodiment in which an electronic device according to an embodiment operates in a NSTR mode.

Referring to FIG. 3B, a wireless LAN system 300 may include an electronic device 310 and/or an external electronic device 320. According to an embodiment, the electronic device 310 may perform wireless communication with an external electronic device 320 via short-range wireless communication. The wireless communication may refer to various communication methods that may be supported by both the electronic device 310 and/or the external electronic device 320. For example, the wireless communication may be Wi-Fi. The external electronic device 320 may serve as a base station that provides wireless communication to at least one electronic device 310 located within a communication radius of the wireless LAN system 300. According to an embodiment, the external electronic device 320 may include an IEEE 802.11 access point (AP). The electronic device 310 may include a station (STA) of IEEE 802.11.

According to an embodiment, the electronic device 310 and/or the external electronic device 320 may support multi-link operation (MLO). The multi-link operation may be an operation mode in which data is transmitted or received via multiple links (e.g., a first link 331 and a second link 332). The multi-link operation may be an operation mode which is planned to be introduced in IEEE 802.11be and in which data is transmitted or received through multiple links based on multiple bands or channels.

According to an embodiment, the electronic device 310 may include multiple communication circuits (e.g., a first communication circuit 311 and/or a second communication circuit 312) to support multi-link operation. The first communication circuit 311 may transmit data to the external electronic device 320 via the first link 331 or may receive data transmitted from the external electronic device 320 via the first link 331. The first communication circuit 311 may output or receive a signal of a frequency band corresponding to the first link 331 via a first antenna 313. The second communication circuit 312 may transmit data to the external electronic device 320 via the second link 332, or may receive data transmitted from the external electronic device 320 via the second link 332. The second communication circuit 312 may output or receive a signal of a frequency band corresponding to the second link 332 via a second antenna 314.

According to an embodiment, the external electronic device 320 may include multiple communication circuits (e.g., a third communication circuit 321 and/or a fourth communication circuit 322) to support multi-link operation. The third communication circuit 321 may transmit data to the electronic device 310 via the first link 331 or may receive data transmitted from the electronic device 310 via the first link 331. The third communication circuit 321 may output or receive a signal of a frequency band corresponding to the first link 331 via a third antenna 323. The fourth communication circuit 322 may transmit data to the electronic device 310 via the second link 332, or may receive data transmitted from the electronic device 310 via the second link 332. The fourth communication circuit 322 may output or receive a signal of a frequency band corresponding to the second link 332 via a fourth antenna 324.

According to an embodiment, the frequency band of the first link 331 and the frequency band of the second link 332 may be different. For example, the frequency band of the first link 331 may be 2.5 GHz, and the frequency band of the second link 332 may be 5 GHz.

According to an embodiment, the electronic device 310 may not be able to sufficiently secure a space 351 between the first antenna 313 and the second antenna 314 due to implementation reasons. According to an embodiment, when the space 351 between the first antenna 313 and the second antenna 314 is not secured sufficiently, signals output by the first antenna 313 and signals received via the second antenna 314 may cause interference with each other. For example, the second antenna 314 may receive a signal in which the signal received via the second link 332 and a part of the signal output by the first antenna 313 are combined, and thus the quality of the signal received via the second link 332 may be degraded.

According to an embodiment, the electronic device 310 may support a NSTR mode to avoid situations where the signals output by the first antenna 313 and the signals output by the second antenna 314 interfere with each other. The NSTR mode may refer to a mode in which the electronic device 310 does not receive data via the second link 332 when transmitting data to the external electronic device 320 via the first link 331. The NSTR mode may support an operation of receiving data via the second link 332 while receiving data via the first link 331 and/or an operation of transmitting data via the second link 332 while transmitting data via the first link 331.

FIG. 3C illustrates an embodiment in which an electronic device according to an embodiment operates in an enhanced multi-link with single radio (EMLSR) mode.

Referring to FIG. 3C, a wireless LAN system 300 may include an electronic device 310 and/or an external electronic device 320. According to an embodiment, the electronic device 310 may perform wireless communication with the external electronic device 320 via short-range wireless communication. The wireless communication may refer to various communication methods that may be supported by both the electronic device 310 and/or the external electronic device 320. For example, the wireless communication may be Wi-Fi. The external electronic device 320 may serve as a base station providing wireless communication to at least one electronic device 310 located within a communication radius of the wireless LAN system 300. According to an embodiment, the external electronic device 320 may include an IEEE 802.11 access point (AP). The electronic device 310 may include a station (STA) of IEEE 802.11.

According to an embodiment, the electronic device 310 and/or the external electronic device 320 may support multi-link operation (MLO). The multi-link operation may be an operation mode in which data is transmitted or received through multiple links (e.g., a first link 331 and a second link 332). The multi-link operation may be an operation mode planned to be introduced in IEEE 802.11be and in which data is transmitted or received through multiple links based on multiple bands or channels.

According to an embodiment, the electronic device 310 may include a first communication circuit 311 to support multi-link operation. The first communication circuit 311 may transmit data to the external electronic device 320 via the first link 331, or may receive data transmitted from the external electronic device 320 via the first link 331. The first communication circuit 311 may transmit data to the external electronic device 320 via the second link 332, or may receive data transmitted from the external electronic device 320 via the second link 332. The first communication circuit 311 may output or receive a signal of a frequency band corresponding to the first link 331 through a first antenna 313, and may output or receive a signal of a frequency band corresponding to the second link 332 through a second antenna 314.

According to an embodiment, the external electronic device 320 may include multiple communication circuits (e.g., a third communication circuit 321 and/or a fourth communication circuit 322) to support multi-link operation. The third communication circuit 321 may transmit data to the electronic device 310 via the first link 331, or may receive data transmitted from the electronic device 310 via the first link 331. The third communication circuit 321 may output or receive a signal of a frequency band corresponding to the first link 331 via the third antenna 323. The fourth communication circuit 322 may transmit data to the electronic device 310 via the second link 332, or may receive data transmitted from the electronic device 310 via the second link 332. The fourth communication circuit 322 may output or receive a signal of a frequency band corresponding to the second link 332 via the fourth antenna 324.

According to an embodiment, the frequency band of the first link 331 and the frequency band of the second link 332 may be different. For example, the frequency band of the first link 331 may be 2.5 GHz, and the frequency band of the second link 332 may be 5 GHz.

According to an embodiment, the electronic device 310 may support multi-link operations using multiple links, by using one communication circuit (e.g., the first communication circuit 311) for implementation reasons. In this case, the electronic device 310 may perform an enhanced multi-link single radio (EMLSR) mode in which data that is relatively small in size (e.g., control data, RTS frames, CTS frames, and ACK messages) may be transmitted through multiple links (e.g., a first link 331 and a second link 332), but data that is relatively large in size may be transmitted through a single link (e.g., first link 331). The EMLSR mode may refer to a mode in which relatively small data is transmitted/received using multiple links and relatively large data is transmitted/received using a single link. The electronic device 310 operating in the EMLSR mode may not receive data via the second link 332 when transmitting relatively large data to the external electronic device 320 via the first link 331.

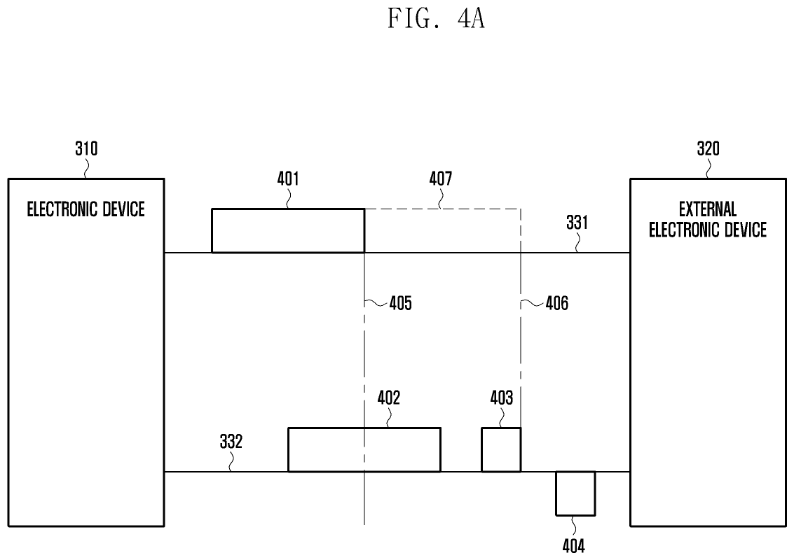

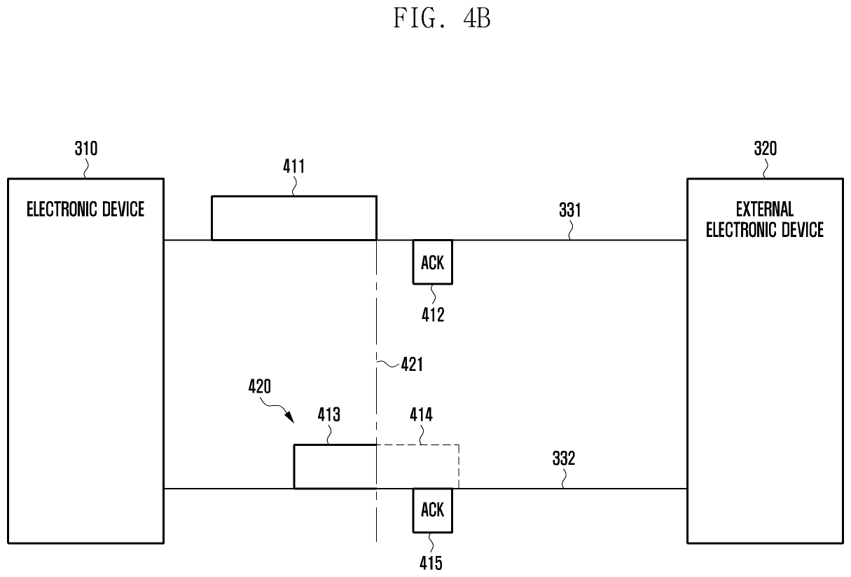

FIG. 4A illustrates an example in which an electronic device according to an embodiment operates in a first acknowledgement message transmission mode.

The electronic device (e.g., the electronic device 310 of FIG. 3A) may transmit data to an external electronic device (e.g., the external electronic device 320 of FIG. 3A) via a first link (e.g., the first link 331 of FIG. 3A) and/or a second link (e.g., the second link 332 of FIG. 3A), and then may receive an acknowledgement message transmitted from the external electronic device 320. The acknowledgement message may refer to a message indicating that reception of the data transmitted by the electronic device 310 is completed. The electronic device 310 may transmit a physical protocol data unit (PPDU), which refers to data in which multiple pieces of data are combined, to the external electronic device 320. The external electronic device 320 may transmit, to the electronic device 310, an acknowledgement message (e.g., a block ack) indicating that the reception of the multiple pieces of data is complete as a whole, rather than transmitting separately acknowledgement messages indicating that the reception of each of the multiple pieces of data is complete.

The electronic device 310 and the external electronic device 320 may perform negotiation to determine a transmission policy for the acknowledgement message (or a reception policy for the acknowledgement message), and may exchange acknowledgement messages through the acknowledgement message transmission policy determined through the negotiation.

The acknowledgement message transmission policy may include a first acknowledgement message transmission mode, in which an electronic device (e.g., the external electronic device 320) that has received data transmits an acknowledgement message when the electronic device has completed receiving of the data and has received an acknowledgement message transmission request, which is a message requesting transmission of the acknowledgement message, from an electronic device (e.g., the electronic device 310) that has transmitted the data. The first acknowledgement message transmission mode may be referred to as a delayed block ack message mode, and an acknowledgement message exchanged via the first acknowledgement message transmission mode may be referred to as a delayed block ack.

The acknowledgement message transmission policy may include a second acknowledgement message transmission mode, in which the electronic device (e.g., external electronic device 320) that has received data completes receiving of the data and transmits the acknowledgement message after a designated time (e.g., short inter frame space (SIFS)). The second acknowledgement message transmission mode may be referred to as an immediate block ack message mode, and an acknowledgement message exchanged via the second acknowledgement message transmission mode may be referred to as an immediate block ack.

The acknowledgement message transmission policy may be configured independently for each link established (or formed) between the electronic device 310 and the external electronic device 320. According to an embodiment, the first link 331 may be configured as a first acknowledgement message transmission mode, and the second link 332 may be configured as a second acknowledgement message transmission mode.

FIG. 4A illustrates an example of a case in which an acknowledgement message transmission policy of the first link 331 and the second link 332 established between the electronic device 310 and the external electronic device 320 is configured as the first acknowledgement message transmission mode.

Referring to FIG. 4A, the electronic device 310 may transmit data 401 to the external electronic device 320 via the first link 331. The external electronic device 320 may not immediately transmit an acknowledgement message (or may wait to transmit an acknowledgement message) after receiving of the data 401 via the first link 331.

While transmitting the data 401 to the external electronic device 320 via the first link 331, the electronic device 310 may transmit the data 402 to the external electronic device 320 via the second link 332. Referring to FIG. 4A, a time point at which transmission of the data 402 via the second link 332 is completed may be later than a time point at which the transmission of the data 401 via the first link 331 is completed. The electronic device 310 may, after completion of transmitting of the data 402 via the second link 332, transmit an acknowledgement message transmission request message 403 to the external electronic device 320. A link through which the acknowledgement message transmission request message 403 is transmitted may be at least one of the first link 331 or the second link 332. In FIG. 4A, although the acknowledgement message transmission request message 403 is illustrated as being transmitted via the second link 332, the acknowledgement message transmission request message 403 may also be transmitted via the first link 331.

Upon receiving the acknowledgement message transmission request message 403, the external electronic device 320 may transmit an acknowledgement message 404 to the electronic device 310. A link through which the acknowledgement message 404 is transmitted may be at least one of the first link 331 or the second link 332. In FIG. 4A, although the acknowledgement message 404 is shown being transmitted via the second link 332, but the acknowledgement message may also be transmitted via the first link 331.

In a case that the external electronic device 320 operates in a NSTR mode due to various causes, the external electronic device 320 may not receive data via the second link 332 (or the first link 331) while transmitting data via the first link 331 (or the second link 332). Referring to FIG. 4A, the external electronic device 320 may have difficulty transmitting data via the first link 331 during a period 407 between a time point 405 at which receiving of data via the first link 331 is completed and a time point 406 at which the acknowledgement message transmission request message is received.

For example, the external electronic device 320 may not be able to transmit data in a case of transmitting data (time sensitive data) associated with a latency-sensitive service via the first link 331 during a period 407 between a time point 405 at which receiving of data via the first link 331 is completed and a time point 406 at which the acknowledgement message transmission request message is received. Therefore, the quality of the latency-sensitive service may be degraded.

FIG. 4B illustrates an example in which an electronic device according to an embodiment operates in a second acknowledgement message transmission mode.

The electronic device (e.g., the electronic device 310 of FIG. 3A) may transmit data to an external electronic device (e.g., the external electronic device 320 of FIG. 3A) via a first link (e.g., the first link 331 of FIG. 3A) and/or a second link (e.g., the second link 332 of FIG. 3A), and then may receive an acknowledgement message transmitted by the external electronic device 320. The acknowledgement message may refer to a message indicating that reception of the data transmitted from the electronic device 310 is completed. The electronic device 310 may transmit a physical protocol data unit (PPDU), which refers to data in which multiple pieces of data are combined, to the external electronic device 320. The external electronic device 320 may transmit, to the electronic device 310, an acknowledgement message (e.g., a block ack) indicating that the reception of the multiple pieces of data is complete as a whole, instead of transmitting separately acknowledgement messages indicating that the reception of each of the multiple pieces of data is completed.

The electronic device 310 and the external electronic device 320 may perform negotiation to determine a transmission policy for the acknowledgement message (or a reception policy for the acknowledgement message), and may exchange acknowledgement messages through the acknowledgement message transmission policy determined through the negotiation.

The acknowledgement message transmission policy may include a first acknowledgement message transmission mode, in which an electronic device (e.g., the external electronic device 320) that has received data transmits an acknowledgement message when the electronic device has completed receiving of the data and has received an acknowledgement message transmission request, which is a message requesting transmission of the acknowledgement message, from an electronic device (e.g., the electronic device 310) that has transmitted the data. The first acknowledgement message transmission mode may be referred to as a delayed block ack message mode, and an acknowledgement message exchanged via the first acknowledgement message transmission mode may be referred to as a delayed block ack.

The acknowledgement message transmission policy may include a second acknowledgement message transmission mode, in which the electronic device (e.g., external electronic device 320) that has received data has completed receiving of the data and transmits the acknowledgement message after a designated time (e.g., short inter frame space (SIFS)). The second acknowledgement message transmission mode may be referred to as an immediate block ack message mode, and an acknowledgement message exchanged via the second acknowledgement message transmission mode may be referred to as an immediate block ack.

The acknowledgement message transmission policy may be configured independently for each link established (or formed) between the electronic device 310 and the external electronic device 320. According to an embodiment, the first link 331 may be configured as a first acknowledgement message transmission mode, and the second link 332 may be configured as a second acknowledgement message transmission mode.

FIG. 4B illustrates an example of a case in which an acknowledgement message transmission policy of the first link 331 and the second link 332 established between the electronic device 310 and the external electronic device 320 is configured as the second acknowledgement message transmission mode.

Referring to FIG. 4B, the electronic device 310 may transmit data 411 to the external electronic device 320 via the first link 331. While transmitting the data 411 to the external electronic device 320 via the first link 331, the electronic device 310 may transmit, to the external electronic device 320, a portion 413 of data 420 to be transmitted via the second link 332. The external electronic device 320 may transmit an acknowledgement message 412 immediately after completion of receiving of the data 411 via the first link 331. Upon receiving the acknowledgement message 412, the electronic device 310 may transmit other data (not shown) to the external electronic device 320 via the first link 331. The second acknowledgement message transmission mode may reduce a time consumed to transmit (or receive) data due to the faster transmission (or reception) of the acknowledgement message 412.

According to an embodiment, when the external electronic device 320 operates in a NSTR mode due to various causes, the external electronic device 320 may not receive data via the second link 332 (or the first link 331) while transmitting data via the first link 331 (or the second link 332).

The electronic device 310 may, when the acknowledgement message transmission policy of the first link 331 is configured as the second acknowledgement message transmission mode and the external electronic device 320 operates in the NSTR mode, perform scheduling, for the transmission of the acknowledgement message 412 by the external electronic device 320, to avoid transmitting data via the second link 332 after the transmission of data via the first link 331 is completed. Performing the scheduling to avoid transmitting data via the second link 332 after the transmission of data via the first link 331 is completed may be referred to as PPDU end time alignment.

According to an embodiment, the electronic device 310 may not allow the transmission of data 414 via the second link 332 after a time point 421 at which the transmission of data 411 via the first link 331 is completed. This is because the external electronic device 320 operating in the NSTR mode is unable to receive the data 414 via the second link 332 while transmitting the acknowledgement message 412 via the first link 331. A portion 414 of the data 420 to be transmitted via the second link 332 may not be transmitted to the external electronic device 320 due to the transmission (or reception) of the acknowledgement message via the first link 331. However, since the external electronic device 320 is capable of simultaneously transmitting data via multiple links, the external electronic device 320 may transmit an acknowledgement message 415 corresponding to the received data 413 to the electronic device 310 via the second link 332.

For example, when the external electronic device 320 needs to receive data (time-sensitive data) associated with a latency-sensitive service via the second link 332, the external electronic device 320 may not be able to receive the data associated with the latency-sensitive service due to the transmission of the acknowledgement message 412 via the first link 331. Accordingly, the quality of the latency-sensitive service may be degraded.

In the below, an example of reducing a latency of data transmission (or reception) by configuring an acknowledgement message transmission policy according to transmission of data satisfying a designated condition of multiple links is described.

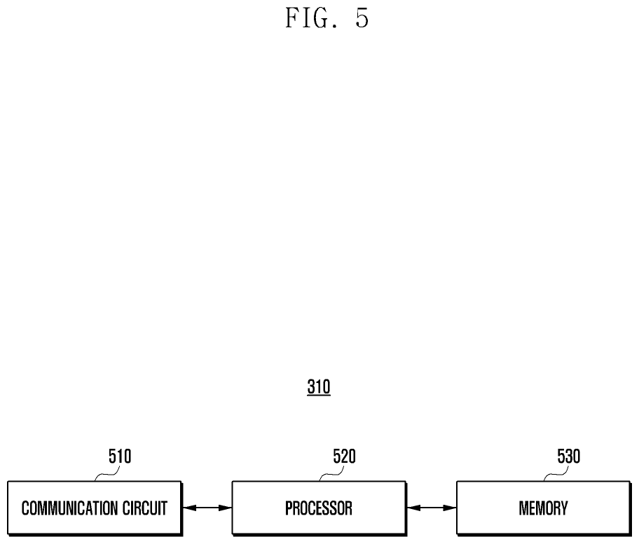

FIG. 5 is a block diagram of an electronic device according to an embodiment.

According to an embodiment, the electronic device (e.g., the electronic device 310 of FIG. 3) may include a communication circuit (e.g., the wireless communication module 192 of FIG. 1) 510, a processor (e.g., the processor 120 of FIG. 1) 520, and/or a memory (e.g., the memory 130 of FIG. 1) 530.

The communication circuit 510 may include various circuit structures used to modulate and/or demodulate signals within the electronic device 310. For example, the communication circuit 510 may modulate a baseband signal into a radio frequency (RF) band signal to be output through an antenna (not shown), or may demodulate an RF band signal received through the antenna into a baseband signal and transmit the same to the processor 520.

The communication circuit 510 may perform short-range wireless communication through a first frequency band (e.g., 2.4 GHz), a second frequency band (e.g., 5 GHz) that is a higher frequency band than the first frequency band, and/or a third frequency band (e.g., 6 GHz) that is a higher frequency band than the second frequency band.

The communication circuit 510 may transmit multiple packets to the external electronic device (e.g., the external electronic device 320 of FIG. 3A) via the first link (e.g., the first link 331 of FIG. 3A), or may receive data transmitted from the external electronic device 320 via the first link 331. The communication circuit 510 may transmit packets to the external electronic device 320 via the second link (e.g., the second link 332 of FIG. 3A), or receive packets transmitted from the external electronic device 320 via the second link 332. The communication circuit 510 may output or receive a signal of a frequency band corresponding to the first link 331 through an antenna (not shown), and may output or receive a signal of a frequency band corresponding to the second link 332 through an antenna (not shown).

The communication circuit 510 may perform an operation of receiving signals transmitted from the external electronic device 320, based on control of the processor 520. The communication circuit 450 may receive, from the processor 520, a signal requesting to transmit and/or receive data through a specific channel, and may control elements of the communication circuit 510 (e.g., a low noise amplifier, a switch, and/or a filter) to receive a signal through a frequency band corresponding to the specific channel.

The electronic device 310 may support a simultaneous transmission and reception (STR) mode in which data transmission and/or reception simultaneously occur through multiple links, including the first link 331 and/or the second link 332. For example, the communication circuit 510 may transmit or receive data to or from the external electronic device 320 via the second link 332 while transmitting or receiving data to or from the external electronic device 320 via the first link 331. However, in a situation in which a difference between the frequency band of the first link 331 and the frequency band of the second link 332 has a value less than or equal to a designated magnitude, the communication circuit 510 may operate in a non-simultaneous transmit and receive (NSTR) mode to prevent interference between the transmission and reception of data via the first link 331 and the transmission and reception of data via the second link 332. The NSTR mode may be understood as a mode in which the electronic device 310 does not receive data via the second link 332 when transmitting data via the first link 331 to the external electronic device 320.

The processor 520 may perform an operation of receiving data transmitted by an application processor (e.g., the processor 120 of FIG. 1) and generating a packet for transmission of the received data to the external electronic device 320. The processor 520 may be defined as a communication processor (or a communication processor) included in a communication module (e.g., the wireless communication module 192 of FIG. 1). According to an embodiment, the processor 520 may generate a packet by performing channel coding based on data transmitted by the application processor 120 or identify whether at least a portion of the data transmitted by the external electronic device 320 has an error, and when an error occurs, perform an operation of recovering from the error (e.g., a hybrid auto repeat request (HARQ)).

The processor 520 may be operatively coupled to the communication circuit 510 to control the operation of the communication circuit 510.

The memory 530 may store instructions that may be executed by the processor 520. The operations of the processor 520 described below may be performed in accordance with the execution of the instructions stored in the memory 530.

The processor 520 may receive, from the external electronic device 320, information indicating that the external electronic device 320 operates in one of the NSTR mode or the simultaneous transmit and reception (STR) mode. The information indicating that the external electronic device 320 operates in either the NSTR mode or the STR mode may be received through at least one of the first link 331 and/or the second link 332 established between the electronic device 310 and the external electronic device 320, and may be received via a frame defined in various methods (e.g., a beacon frame and an action frame).

The processor 520 may identify whether the external electronic device 320 operates in a NSTR mode, based on the information indicating that the external electronic device 320 operates in either the NSTR mode or the STR mode. The NSTR mode may refer to a mode in which the external electronic device 320 does not receive data via the second link 332 when the external electronic device 320 transmits data to the electronic device 310 via the first link 331.

According to an embodiment, the processor 520 may, in a case that the external electronic device 320 operates in a NSTR mode, which is a mode in which the external electronic device does not receive data via the second link 332 when transmitting data to the electronic device 310 via the first link 331, identify whether data satisfying a designated condition is configured to be transmitted to and/or received from the external electronic device 320 via the second link 332.

In order to identity whether data satisfying the designated condition is configured to be transmitted to and/or received from the external electronic device 320 via the second link 332, the processor 520 may refer to mapping data that includes types of data that may be transmitted or received via the second link 332.

According to an embodiment, the designated condition may include a condition requiring low latency. According to an embodiment, data satisfying the designated condition may include data associated with services that require low latency. Data that fails to satisfy the designated condition may include data associated with services that can be performed smoothly even at a relatively high delay rate.

According to an embodiment, the designated condition may include a condition in which the priority of the data transmitted and/or received via the second link 332 is higher than the priority of the data transmitted and/or received via the first link 331. The higher priority data may be transmitted and/or received preferentially than the lower priority data.

The type of data may refer to a type of service (TID) as defined in IEEE 802.11. According to an embodiment, the type of data may include a first type (e.g., voice data type (VO) or video data type (VI)) that requires a relatively high transmission rate or low latency (e.g., real-time) and/or a second type (e.g., background (BK) and/or best effort (BE)) that is a type of data that may be performed at a relatively low transmission rate or high latency compared to the first type.

Mapping data refers to data in which a data type and a link are mapped, and data having a specific data type may be data that indicates to perform transmission and/or reception through a specific link. For example, mapping data may refer to TID-to-link mapping data as defined in IEEE 802.11.

For example, the mapping data may be implemented as shown in Table 1 below.

TABLE 1
Types of data that may be transmitted via the second link 332
BE
BK

Referring to Table 1, the data transmittable via the second link 332 may be data having a data type that may be executed at a relatively low transmission rate or high latency, and may include data that fails to satisfy the designated condition.

In another example, the mapping data may be implemented as shown in Table 2 below.

TABLE 2
Types of data that may be transmitted via the second link 332
VO
VI

Referring to Table 2, the data transmittable via the second link 332 may be data having a data type that requires a relatively high transmission rate or low latency, and may include data satisfying designated condition.

Based on the mapping data described above, the processor 520 may identify whether data satisfying the designated condition is configured to be transmitted to and/or received from the external electronic device 320 via the second link 332.

In a case that data satisfying the designated condition is configured to be transmitted to and/or received from the external electronic device 320 via the second link 332 (e.g., Table 2), the processor 520 may identify whether data is transmitted to the external electronic device 320 via the second link 332 when transmitting data to the external electronic device 320 via the first link 331. The processor 520 may determine an acknowledgement message transmission policy of the first link 331 based on whether data is transmitted to the external electronic device 320 via the second link 332 when transmitting data to the external electronic device 320 via the first link 331. The acknowledgement message transmission policy may include a first acknowledgement message transmission mode, in which the electronic device (e.g., the external electronic device 320) that has received data transmits an acknowledgement message when the electronic device has completed receiving of the data and has received an acknowledgement message transmission request, which is a message requesting transmission of the acknowledgement message, from the electronic device (e.g., the electronic device 310) that has transmitted the data. The first acknowledgement message transmission mode may be referred to as a delayed block ack message mode, and an acknowledgement message exchanged via the first acknowledgement message transmission mode may be referred to as a delayed block ack.

The acknowledgement message transmission policy may include a second acknowledgement message transmission mode, in which the electronic device (e.g., external electronic device 320) that has received data has completed receiving of the data and then transmits the acknowledgement message after a designated period of time (e.g., short inter frame space (SIFS)). The second acknowledgement message transmission mode may be referred to as an immediate block ack message mode, and the acknowledgement message exchanged via the second acknowledgement message transmission mode may be referred to as an immediate block ack.

Determining of the acknowledgement message transmission policy of the first link 331 by the processor 520 may include selecting one of the first acknowledgement message transmission mode or the second acknowledgement message transmission mode. The acknowledgement message policy of the first link 331 may be determined to minimize the latency of transmitting data satisfying designated conditions via the second link 332. Alternatively, the determination of the acknowledgement message transmission policy of the first link 331 may be determined such that services associated with the data satisfying the designated condition can be performed smoothly via the second link 332.

When data is transmitted to the external electronic device 320 via the first link 331, the processor 520 may identify whether data transmission to the external electronic device 320 via the second link 332 is initiated (or data is being transmitted to the external electronic device 320 via the second link 332).

When data is transmitted to the external electronic device 320 via the first link 331, not initiating the transmission of data to the external electronic device 320 via the second link 332 (or not transmitting data to the external electronic device 320 via the second link 332) may indicate that the transmission of the data via the first link 331 is performed before the transmission of the data via the second link 332.

The processor 520 may determine (or select) an acknowledgement message transmission policy of the first link 331 as a first acknowledgement message transmission mode, based on identifying that when data is transmitted to the external electronic device 320 via the first link 331, no data is being transmitted to the external electronic device 320 via the second link 332.

Based on determining (or selecting) the acknowledgement message transmission policy of the first link 331 as the first acknowledgement message transmission mode, the processor 520 may not receive an acknowledgement message from the external electronic device 320 within a designated time (e.g., SIFS) after the transmission of data via the first link 331 is completed. The external electronic device 320 operating in a NSTR mode may not transmit an acknowledgement message via the first link 331, thereby maintaining data reception via the second link 332. Accordingly, the processor 520 may maintain transmission of data satisfying the designated condition via the second link 332 even when transmission of data via the first link 331 is completed, and may reduce the time required to transmit data satisfying the designated condition.

If the processor 520 determines the acknowledgement message transmission policy of the first link 331 as a second acknowledgement message transmission mode, the processor 520 may receive an acknowledgement message from the external electronic device 320 within a designated time (e.g., SIFS) after the transmission of data via the first link 331 is completed. The external electronic device 320 operating in a NSTR mode should transmit the acknowledgement message via the first link 331 and may not be able to perform the reception of data via the second link 332 due to the transmission of the acknowledgement message via the first link 331. The reception of data through the second link 332 is impossible and thus the latency required to transmit data satisfying the designated condition via the second link 332 may increase. By determining (or selecting) the acknowledgement message transmission policy of the first link 331 as the first acknowledgement message transmission mode, the processor 520 may prevent (or suppress) the increase in latency for transmitting data satisfying the designated condition via the second link 332.

The processor 520 may, when transmission of data satisfying the designated condition via the second link 332 is completed, transmit an acknowledgement message transmission request message (or signal) to the external electronic device 320 through at least one of the first link 331 and/or the second link 332. Upon receiving the acknowledgement message transmission request message (or signal), the external electronic device 320 may transmit, to the electronic device 310, an acknowledgement message indicating that the reception of the data via the first link 331 is completed and/or an acknowledgement message indicating that the reception of the data via the second link 332 is completed. The external electronic device 320 may also transmit an acknowledgement message (e.g., a multiple-station block acknowledgement (multi-STA BA)) obtained by combining an acknowledgement message indicating that the reception of data via the first link 331 is completed and/or an acknowledgement message indicating that the reception of the data via the second link 332 is completed.

Based on reception of the acknowledgement message, the processor 520 may transmit other data to the external electronic device 320 via the first link 331 and/or the second link 332.

The transmission of data to the external electronic device 320 via the second link 332, which has already been initiated when data is transmitted to the external electronic device 320 via the first link 331, may refer to the transmission of data via the second link 332 being performed before the transmission of data via the first link 331.

The processor 520 may determine (or select) an acknowledgement message transmission policy of the first link 331 as a second acknowledgement message transmission mode, based on the identifying that data is being transmitted to the external electronic device 320 via the second link 332 when transmitting data to the external electronic device 320 via the first link 331.

It may be advantageous for the external electronic device 320 operating in a NSTR mode to transmit, within a designated time, an acknowledgement message indicating that the reception of data via the second link 332 is completed in order to reduce latency in the transmission and/or reception of data satisfying designated conditions via the second link 332. Accordingly, the electronic device 310 and/or the external electronic device 320 may determine an acknowledgement message transmission policy of the second link 332 as a second acknowledgement message transmission mode. The processor 520 may determine the acknowledgement message transmission policy of the first link 331 as the second acknowledgement message transmission mode to facilitate transmission and/or reception of the acknowledgement message via the second link 332.

Based on determining (or selecting) the acknowledgement message transmission policy of the first link 331 as the second acknowledgement message transmission mode, the processor 520 may perform transmission of data via the first link 331. The size of the data transmitted via the first link 331 may be determined based on a time point at which the transmission of the data via the second link 332 is completed. According to an embodiment, the processor 520 may determine the size of the data to be transmitted via the first link 331 so that the transmission of the data via the first link 331 is able to be completed by the time point at which the transmission of the data via the second link 332 is completed. In a case that the size of the data is larger than the determined size, the processor 520 may split the data and transmit the split data via the first link 331, and the remaining data may be transmitted later via the first link 331.

The processor 520 may transmit data via the first link 331 until the transmission of data via the second link 332 is completed. When transmission of data via the second link 332 is completed, the transmission of data via the first link 331 may be suspended in order to wait for reception of an acknowledgement message via the second link 332. The above operation considers the external electronic device 320 operating in a NSTA mode, and the external electronic device 320 operating in the NSTA mode may not be able to transmit data (or an acknowledgement message) via the second link 332 while receiving data via the first link 331. Accordingly, the processor 520 may suspend transmission of data via the first link 331 during an interval in which the external electronic device 320 is able to transmit an acknowledgement message via the second link 332.

The processor 520 may receive the acknowledgement message within a designated time (e.g., SIFS) after the transmission of data via the first link 331 is completed, based on determining (or selecting) the acknowledgement message transmission policy of the first link 331 as the second acknowledgement message transmission mode.

Alternatively, the processor 520 may determine the acknowledgement message transmission policy of the first link 331 to be the same as the acknowledgement message transmission policy of the second link 332, based on identifying that data is being transmitted to the external electronic device 320 via the second link 332 when transmitting data to the external electronic device 320 via the first link 331.

For example, in a case that data is being transmitted to the external electronic device 320 via the second link 332 when transmitting data to the external electronic device 320 via the first link 331 and that the acknowledgement message transmission policy of the second link 332 is the second acknowledgement message transmission mode, the processor 520 may determine the acknowledgement message transmission policy of the first link 331 as the second acknowledgement message transmission mode.

In another example, in a case that data is being transmitted to the external electronic device 320 via the second link 332 when transmitting data to the external electronic device 320 via the first link 331 and that the acknowledgement message transmission policy of the second link 332 is the first acknowledgement message transmission mode, the processor 520 may determine the acknowledgement message transmission policy of the first link 331 as the first acknowledgement message transmission mode.

In a case that data satisfying designated conditions is not configured to be transmitted to and/or received from the external electronic device 320 via the second link 332 (e.g., Table 1), the processor 520 may identify and/or compare the size of data that failed to be transmitted due to the transmission of the acknowledgement message of the first link 331, among data to be transmitted via the second link 332, when the acknowledgement message transmission policy of the first link 331 is the second acknowledgement message transmission mode, and the size of data that failed to be transmitted via the first link 331 due to data transmission via the second link 332 when the acknowledgement message transmission policy of the first link 331 is the first acknowledgement message transmission mode.

The processor 520 may determine an acknowledgement message transmission policy of the first link 331 based on a result of the comparison.

According to an embodiment, when the size of data that failed to be transmitted due to the reception of the acknowledgement message of the first link 331, among data to be transmitted via the second link 332, when the acknowledgement message transmission policy of the first link 331 is the second acknowledgement message transmission mode is larger than or equal to (or exceeds) the size of data that failed to be transmitted via the first link 331 due to data transmission via the second link 332 when the acknowledgement message transmission policy of the first link 331 is the first acknowledgement message transmission mode, the processor 520 may determine the acknowledgement message transmission policy of the first link 331 as the first acknowledgement message transmission mode.

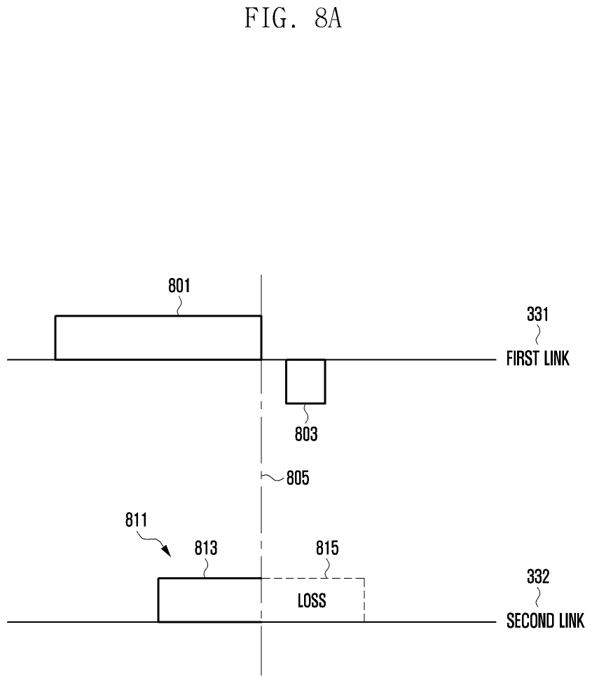

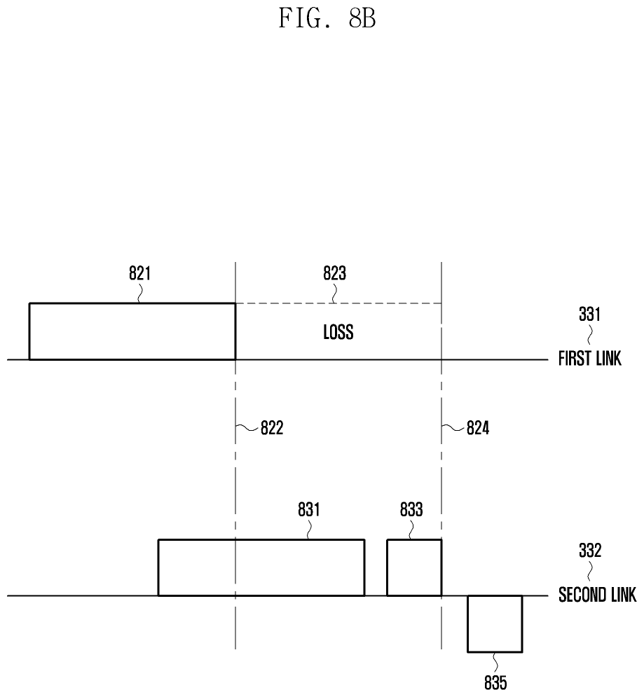

According to an embodiment, when the size of data that failed to be transmitted due to the transmission of the acknowledgement message of the first link 331, among data to be transmitted via the second link 332, when the acknowledgement message transmission policy of the first link 331 is the second acknowledgement message transmission mode is less than or equal to (or less than) the size of data that failed to be transmitted via the first link 331 due to data transmission via the second link 332 when the acknowledgement message transmission policy of the first link 331 is the first acknowledgement message transmission mode, the processor 520 may determine the acknowledgement message transmission policy of the first link 331 as the second acknowledgement message transmission mode. Specific details will be discussed later in FIGS. 8A and 8B.

The processor 520 may control the communication circuit 510 to transmit information indicating the determined acknowledgement message transmission policy to the external electronic device 320. Transmitting of the information indicating the determined acknowledgement message transmission policy may be an operation performed during negotiation of the acknowledgement message transmission policy. According to an embodiment, the processor 520 may control the communication circuit 510 to transmit, to the external electronic device 320, a negotiation request message (e.g., an add block acknowledgment (ADDBA) request frame) that includes information indicating the determined acknowledgement message transmission policy. In a case of receiving a message indicating acceptance of the external electronic device 320 of the determined acknowledgement message transmission policy, the processor 520 may transmit and/or receive an acknowledgement message, or transmit and/or receive an acknowledgement message request message in accordance with the determined acknowledgement message transmission policy.

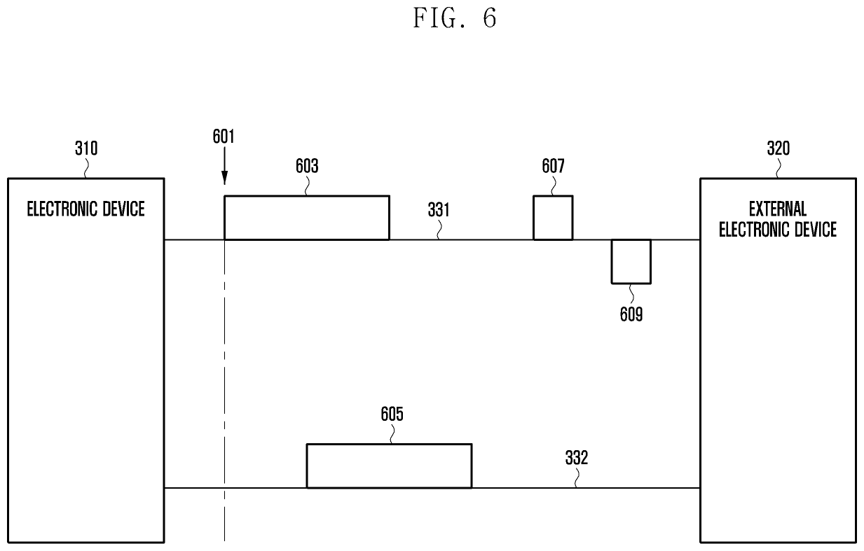

FIG. 6 illustrates an example in which an electronic device according to an embodiment operates in a first acknowledgement message transmission mode based on whether data is transmitted via the second link.

The electronic device (e.g., the electronic device 310 of FIG. 5) may receive information indicating that an external electronic device (e.g., the external electronic device 320 of FIG. 3A) operates in either a NSTR mode or an STR mode from the external electronic device 320. The information indicating that the electronic device 310 operates in either the NSTR mode or the STR mode may be received through at least one of a first link (e.g., the first link 331 in FIG. 3A) and/or a second link (e.g., the second link 332 in FIG. 3A) established between the electronic device 310 and the external electronic device 320, and may be received via a frame (e.g., a beacon frame or action frame) defined in various methods.

The electronic device 310 may identify whether the external electronic device 320 operates in a NSTR mode, based on the information indicating that the external electronic device 320 operates in either the NSTR mode or the STR mode. The NSTR mode may refer to a mode in which the external electronic device 320 does not receive data via the second link 332 when transmitting data to the electronic device 310 via the first link 331.

Hereinafter, it is assumed that the external electronic device 320 operates in a NSTR mode.

In a case that data satisfying designated conditions is configured to be transmitted to and/or received from the external electronic device 320 via the second link 332 (e.g., Table 2), the electronic device 310 may identify whether data is transmitted to the external electronic device 320 via the second link 332 when transmitting data to the external electronic device 320 via the first link 331. The electronic device 310 may determine an acknowledgement message transmission policy of the first link 331 based on whether data is transmitted to the external electronic device 320 via the second link 332 when transmitting data to the external electronic device 320 via the first link 331.

The acknowledgement message transmission policy may include a first acknowledgement message transmission mode, in which the electronic device (e.g., the external electronic device 320) that has received data transmits an acknowledgement message when the electronic device has completed receiving of the data and has received an acknowledgement message transmission request, which is a message requesting transmission of the acknowledgement message, from the electronic device (e.g., the electronic device 310) that has transmitted the data. The first acknowledgement message transmission mode may be referred to as a delayed block ack message mode, and an acknowledgement message exchanged via the first acknowledgement message transmission mode may be referred to as a delayed block ack.

The acknowledgement message transmission policy may include a second acknowledgement message transmission mode, in which the electronic device (e.g., the external electronic device 320) that has received data has completed receiving of the data and then transmits the acknowledgement message after a designated time (e.g., short inter frame space (SIFS)). The second acknowledgement message transmission mode may be referred to as an immediate block ack message mode, and the acknowledgement message exchanged via the second acknowledgement message transmission mode may be referred to as an immediate block ack.

Determining of the acknowledgement message transmission policy of the first link 331 by the electronic device 310 may include selecting one of the first acknowledgement message transmission mode or the second acknowledgement message transmission mode. The acknowledgement message policy of the first link 331 may be determined to minimize the latency of transmitting data satisfying designated conditions via the second link 332. Alternatively, the determination of the acknowledgement message transmission policy of the first link 331 may be determined such that services associated with the data satisfying the designated condition can be performed smoothly via the second link 332.

When data is transmitted to the external electronic device 320 via the first link 331, the electronic device 310 may identify whether data transmission to the external electronic device 320 via the second link 332 is initiated (or data is being transmitted to the external electronic device 320 via the second link 332).

Referring to FIG. 6, the electronic device 310 may not transmit data 605 to the external electronic device 320 via the second link 332 at a time point 601 at which data 603 is initiated to be transmitted to the external electronic device 320 via the first link 331. According to an embodiment, upon detecting that another electronic device has transmitted data via the second link 332, the electronic device 310 may transmit data to the external electronic device 320 via the second link 332 after a designated time (e.g., back-off) from a time point at which the other electronic device has completed transmitting of the data.

The electronic device 310 may determine (or select) an acknowledgement message transmission policy of the first link 331 as a first acknowledgement message transmission mode, based on identifying that when the data 603 is transmitted to the external electronic device 320 via the first link 331, the data 605 is not being transmitted to the external electronic device 320 via the second link 332.

Based on determining (or selecting) the acknowledgement message transmission policy of the first link 331 as the first acknowledgement message transmission mode, the electronic device 310 may not receive an acknowledgement message within a designated time (e.g., SIFS) after the transmission of data 603 via the first link 331 is completed. Since the external electronic device 320 operating in a NSTR mode may not transmit an acknowledgement message via the first link 331, the reception of the data 605 via the second link 332 may be maintained even though the data transmission via the first link 331 is completed. Accordingly, the electronic device 310 may maintain transmission of the data 605 satisfying the designated condition via the second link 332 even when transmission of the data 603 via the first link 331 is completed, and may reduce the time required to transmit the data 605 satisfying the designated condition.

In a case that the electronic device 310 determines the acknowledgement message transmission policy of the first link 331 as a second acknowledgement message transmission mode, the electronic device 310 may receive an acknowledgement message from the external electronic device 320 within a designated time (e.g., SIFS) after the transmission of the data 603 via the first link 331 is completed. The external electronic device 320 operating in a NSTR mode should transmit the acknowledgement message via the first link 331 and may not be able to perform the reception of data 605 via the second link 332 due to the transmission of the acknowledgement message via the first link 331. The reception of data 605 through the second link 332 is impossible and thus the latency required to transmit data 605 satisfying the designated condition via the second link 332 may increase. By determining (or selecting) the acknowledgement message transmission policy of the first link 331 as the first acknowledgement message transmission mode, the electronic device 310 may prevent (or suppress) the increase in latency for transmitting data satisfying the designated condition via the second link 332.

The electronic device 310 may, when transmission of the data 605 satisfying the designated condition via the second link 332 is completed, transmit an acknowledgement message transmission request message (or signal) 607 to the external electronic device 320 through at least one of the first link 331 and/or the second link 332. Referring to FIG. 6, the acknowledgement message transmitting request message 607 is illustrated as being transmitted via the first link 331, but may also be transmitted via the second link 332.

Upon receiving the acknowledgement message transmission request message (or signal) 607, the external electronic device 320 may transmit, to the electronic device 310, an acknowledgement message indicating that the reception of the data 603 via the first link 331 is completed and/or an acknowledgement message 609 indicating that the reception of the data 605 via the second link 332 is completed. The external electronic device 320 may also transmit an acknowledgement message (e.g., a multi-STA BA) obtained by combining an acknowledgement message indicating that the reception of data via the first link 331 is completed and/or an acknowledgement message indicating that the reception of the data 605 via the second link 332 is completed.

Based on reception of the acknowledgement message, the electronic device 310 may transmit other data to the external electronic device 320 via the first link 331 and/or the second link 332.

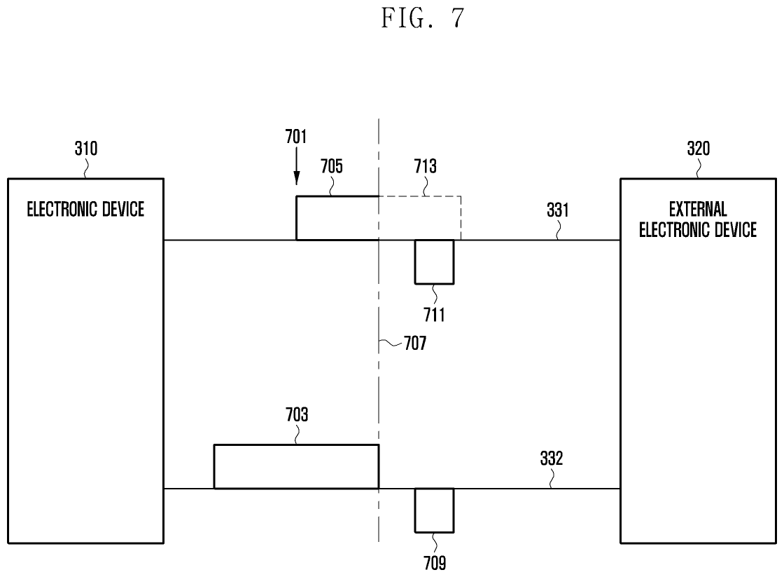

FIG. 7 illustrates an example in which an electronic device according to an embodiment operates in a second acknowledgement message transmission mode based on whether data is transmitted via a second link.

The electronic device (e.g., the electronic device 310 of FIG. 5) may receive information indicating that an external electronic device (e.g., the external electronic device 320 of FIG. 3A) operates in either a NSTR mode or an STR mode from the external electronic device 320. The information indicating that the electronic device 310 operates in either the NSTR mode or the STR mode may be received through at least one of a first link (e.g., the first link 331 in FIG. 3A) and/or a second link (e.g., the second link 332 in FIG. 3A) established between the electronic device 310 and the external electronic device 320, and may be received via a frame (e.g., a beacon frame or action frame) defined in various methods.

The electronic device 310 may identify whether the external electronic device 320 operates in a NSTR mode, based on the information indicating that the external electronic device 320 operates in either the NSTR mode or the STR mode. The NSTR mode may refer to a mode in which the external electronic device 320 does not receive data via the second link 332 when transmitting data to the electronic device 310 via the first link 331.

Hereinafter, it is assumed that the external electronic device 320 operates in a NSTR mode.

In a case that data satisfying designated conditions is configured to be transmitted to and/or received from the external electronic device 320 via the second link 332 (e.g., Table 2), the electronic device 310 may identify whether data is transmitted to the external electronic device 320 via the second link 332 when transmitting data to the external electronic device 320 via the first link 331. The electronic device 310 may determine an acknowledgement message transmission policy of the first link 331 based on whether data is transmitted to the external electronic device 320 via the second link 332 when transmitting data to the external electronic device 320 via the first link 331.

The acknowledgement message transmission policy may include a first acknowledgement message transmission mode, in which the electronic device (e.g., the external electronic device 320) that has received data transmits an acknowledgement message when the electronic device has completed receiving of the data and has received an acknowledgement message transmission request, which is a message requesting transmission of the acknowledgement message, from the electronic device (e.g., the electronic device 310) that has transmitted the data. The first acknowledgement message transmission mode may be referred to as a delayed block ack message mode, and an acknowledgement message exchanged via the first acknowledgement message transmission mode may be referred to as a delayed block ack.

The acknowledgement message transmission policy may include a second acknowledgement message transmission mode, in which the electronic device that has received data has completed receiving of the data and then transmits the acknowledgement message after a designated time (e.g., short inter frame space (SIFS)). The second acknowledgement message transmission mode may be referred to as an immediate block ack message mode, and the acknowledgement message exchanged via the second acknowledgement message transmission mode may be referred to as an immediate block ack.

Determining of the acknowledgement message transmission policy of the first link 331 by the electronic device 310 may include selecting one of the first acknowledgement message transmission mode or the second acknowledgement message transmission mode. The acknowledgement message policy of the first link 331 may be determined to minimize the latency of transmitting data satisfying designated conditions via the second link 332. Alternatively, the determination of the acknowledgement message transmission policy of the first link 331 may be determined such that services associated with the data satisfying the designated condition can be performed smoothly via the second link 332.

When data is transmitted to the external electronic device 320 via the first link 331, the electronic device 310 may identify whether data transmission to the external electronic device 320 via the second link 332 is initiated (or data is being transmitted to the external electronic device 320 via the second link 332).

The transmission of data 703 to the external electronic device 320 via the second link 332, which has already been initiated when data 705 is transmitted to the external electronic device 320 via the first link 331 (indicated by reference numeral 701) may refer to the transmission of data 703 via the second link 332 being performed before the transmission of data 705 via the first link 331.

Referring to FIG. 7, the electronic device 310 may not transmit data 703 to the external electronic device 320 via the second link 332 at a time point 701 at which data 705 is started to be transmitted to the external electronic device 320 via the first link 331.

The electronic device 310 may determine (or select) an acknowledgement message transmission policy of the first link 331 as a second acknowledgement message transmission mode, based on identifying that when the data 705 is transmitted to the external electronic device 320 via the first link 331, the data 703 is being transmitted to the external electronic device 320 via the second link 332.

It may be advantageous for the external electronic device 320 operating in a NSTR mode to transmit, within a designated time, an acknowledgement message 709 indicating that the reception of data via the second link 332 is completed in order to reduce latency in the transmission and/or reception of data 703 satisfying designated conditions via the second link 332. Accordingly, the electronic device 310 and/or the external electronic device 320 may determine an acknowledgement message transmission policy of the second link 332 as a second acknowledgement message transmission mode. The electronic device 310 may determine the acknowledgement message transmission policy of the first link 331 as the second acknowledgement message transmission mode to facilitate transmission and/or reception of the acknowledgement message via the second link 332.

Based on determining (or selecting) the acknowledgement message transmission policy of the first link 331 as the second acknowledgement message transmission mode, the electronic device 310 may perform transmission of data 705 via the first link 331. The size of the data 705 transmitted via the first link 331 may be determined based on a time point 707 at which the transmission of the data via the second link 332 is completed. According to an embodiment, the electronic device 310 may determine the size of the data 705 transmitted via the first link 331 so that the transmission of the data 705 via the first link 331 is able to be completed by the time point 707 at which the transmission of the data 703 via the second link 332 is completed. In a case that the size of the data is larger than the determined data size, the electronic device 310 may split the data and transmit the split data via the first link 331, and the remaining data 713 may be transmitted later via the first link 331.

The electronic device 310 may transmit the data 705 via the first link 331 until the transmission of data 703 via the second link 332 is completed (indicated by reference numeral 707). When transmission of data 703 via the second link 332 is completed, the transmission of data 705 or 713 via the first link 331 may be suspended in order to wait for reception of an acknowledgement message 709 via the second link 332. The above operation considers the external electronic device 320 operating in a NSTA mode, and the external electronic device 320 operating in the NSTA mode may not be able to transmit data (or an acknowledgement message) via the second link 332 while receiving data via the first link 331. Accordingly, the electronic device 310 may suspend transmission of data via the first link 331 during an interval in which the external electronic device 320 is able to transmit an acknowledgement message 709 via the second link 332.

The electronic device 310 may receive an acknowledgement message 711 via the first link 331 within a designated time (e.g., SIFS) after the transmission of data via the first link 331 is completed, based on determining (or selecting) the acknowledgement message transmission policy of the first link 331 as the second acknowledgement message transmission mode. In FIG. 7, although the electronic device 310 is shown as capable of receiving the acknowledgement message 711 via the first link 331 and/or the acknowledgement message 709 via the second link 322, the electronic device 310 may receive, via either the first link 331 or the second link 332, an acknowledgement message obtained by combining the acknowledgement message 711 indicating completion of receiving of the data 705 via the first link 331 and an acknowledgement message 713 indicating completion of receiving of the data 703 via the second link 332.

FIGS. 8A and 8B illustrate an example in which an electronic device according to an embodiment operates in either a first acknowledgement message transmission mode or a second acknowledgement message transmission mode based on a data transmission loss rate that may occur when operating in a specific transmission mode.

The electronic device (e.g., the electronic device 310 of FIG. 5) may receive, from an external electronic device (e.g., the external electronic device 320 of FIG. 3A), information indicating that the external electronic device operates in either the NSTR mode or the STR mode. The information indicating that the electronic device 310 operates in either the NSTR mode or the STR mode may be received through at least one of a first link (e.g., first link 331 of FIG. 3A) and/or a second link (e.g., second link 332 of FIG. 3A) established between the electronic device 310 and the external electronic device 320, and may be received via a frame (e.g., a beacon frame or action frame) defined in various methods.

The electronic device 310 may identify whether the external electronic device 320 operates in a NSTR mode, based on the information indicating that the external electronic device 320 operates in either the NSTR mode or the STR mode. The NSTR mode may refer to a mode in which the external electronic device 320 does not receive data via the second link 332 when transmitting data to the electronic device 310 via the first link 331.

Herein, it is assumed that the external electronic device 320 operates in the NSTR mode.

When data satisfying designated conditions is not configured to be transmitted to and/or received from the external electronic device 320 via the second link 332 (e.g., Table 1), the electronic device 310 may identify and/or compare the size of data that failed to be transmitted due to the transmission of the acknowledgement message of the first link 331, among data to be transmitted via the second link 332, when the acknowledgement message transmission policy of the first link 331 is the second acknowledgement message transmission mode, with the size of data that failed to be transmitted via the first link 331 due to data transmission via the second link 332 when the acknowledgement message transmission policy of the first link 331 is the first acknowledgement message transmission mode.

FIG. 8A illustrates an example in which the electronic device 310 and the external electronic device 320 have determined a second acknowledgement message transmission mode as an acknowledgement message transmission policy of the first link 331.

Referring to FIG. 8A, the electronic device 310 may transmit data 801 via the first link 331 and a portion 813 of data 811 via the second link 332. The electronic device 310 may wait for reception of an acknowledgement message 803 via the first link 331 when the transmission of the data 801 via the first link 331 is completed (indicated by reference numeral 805). The electronic device 310 is unable to perform transmission of data 815 via the second link 332 after the transmission of the data 801 via the first link 331 is completed (indicated by reference numeral 805), in order to receive the acknowledgement message 803 via the first link 331.

The electronic device 310 may identify the size of the data 815 that failed to be transmitted via the second link 332 when the acknowledgement message transmission policy of the first link 331 is configured as the second acknowledgement message transmission mode.

According to an embodiment, in identifying the size of the data 815 that failed to be transmitted via the second link 332, the electronic device 310 may use a data rate R₂ of the second link 332, a maximum time Tₘₐₓ allowed for data transmission via the second link 332, and a time T_{PPDU} taken to transmit a portion 813 of the data that has been successfully transmitted. The electronic device 310 may determine the size of the data 815 that failed to be transmitted via the second link 332, using Equation 1 below.

$${Loss}_{1} = ( {T}_{MAX} - {T}_{PPDU} ) * {R}_{2} \qquad [ Equation 1 ]$$

FIG. 8B illustrates an example in which the electronic device 310 and the external electronic device 320 have determined a first acknowledgement message transmission mode as an acknowledgement message transmission policy of the first link 331.

Referring to FIG. 8B, the electronic device 310 may transmit data 821 via the first link 331 and transmit data 831 via the second link 332. Even upon completing the transmission of the data 821 via the first link 331, the electronic device 310 may not transmit, to the external electronic device 320, a message requesting transmission of an acknowledgement message indicating that the reception of the data 821 via the first link 331 is completed, until the transmission of the data 831 via the second link 332 is completed. The electronic device 310 may, after the transmission of the data 831 via the second link 332 is completed, transmit the message 833 requesting transmission of the acknowledgement message indicating that the reception of the data 821 via the first link 331 is completed to the external electronic device 320 via the second link 332. The external electronic device 320 operating in a NSTR mode may not be able to transmit data to the electronic device 310 via the first link 331 until the acknowledgement message transmission request message 833 is received (indicated by reference numeral 824). The external electronic device 320 may transmit an acknowledgement message 835 to the electronic device 310 in response to receiving of the acknowledgement message transmission request message 833.

In FIG. 8B, although the acknowledgement message transmission request message 833 and/or the acknowledgement message 835 are illustrated as being transmitted via the second link 332, the acknowledgement message transmission request message 833 and/or the acknowledgement message 835 may also be transmitted via the first link 331. The acknowledgement message transmission request message 833 and/or the acknowledgement message 835 may be transmitted through different links. For example, the acknowledgement message transmission request message 833 may be transmitted via the first link 331, and the acknowledgement message 835 may be transmitted via the second link 332.

The electronic device 310 may identify the size of data 823 that failed to be transmitted via the first link 331 when the acknowledgement message transmission policy of the first link 331 is configured as the first acknowledgement message transmission mode.

According to an embodiment, in identifying the size of the data 823 that failed to be transmitted via the first link 331, the electronic device 310 may consider the data rate R₁ of the first link 331, a maximum time (Tₘₐₓ) allowed for data transmission via the first link 331, a time (T_{PPDU}) for transmission of the data 831 via the second link 322 until transmission of the data 821 via the first link 331 is complete (indicated by reference numeral 822), a time (e.g., SIFS) between frames (e.g., between the data 831 and the acknowledgement message transmission request message 833), a time (T_{BAR}) consumed transmitting the acknowledgement message transmission request message 833, and/or an occupancy rate of the second link 332 by the external electronic device 320. The electronic device 310 may determine the size of the data 823 that failed to be transmitted via the first link 331 using Equation 2 below.

$${Loss}_{2} = \frac{{T}_{{radio}_{ON}}}{{T}_{{CCA}_{busy}} + {T}_{{radio}_{ON}}} * ( {T}_{MAX} - {T}_{PPDU} + SIFS + {T}_{BAR} ) * {R}_{2} \qquad [ Equation 2 ]$$

(T_{radio}_{_{ON}}): occupancy time of the second link 332 by the external electronic device 320, T_{CCA}_{_{busy}}: occupancy time of the second link 332 by an electronic device other than the external electronic device 320)

The electronic device 310 may compare the size of the data 815 that failed to be transmitted via the second link 332, identified based on Equation 1, with the size of the data 823 that failed to be transmitted via the first link 331, identified based on Equation 2.

According to an embodiment, the electronic device 310 may determine (or select) an acknowledgement message transmission policy of the first link 331 as a first acknowledgement message transmission mode when the size of the data 815 that failed to be transmitted via the second link 332 is larger than or equal to (or exceeds) the size of the data 823 that failed to be transmitted via the first link 331. The size of the data 815 that failed to be transmitted via the second link 332 being larger than or equal to (or exceeding) the size of the data 823 that failed to be transmitted via the first link 331 may indicate that determining the acknowledgement message transmission policy of the first link 331 as the first acknowledgement message transmission mode may implement a higher data rate compared to determining as the second acknowledgement message transmission mode.

According to an embodiment, the electronic device 310 may determine (or select) the acknowledgement message transmission policy of the first link 331 as the second acknowledgement message transmission mode when the size of the data 815 that failed to be transmitted via the second link 332 is less than or equal to (or less than) the size of the data 823 that failed to be transmitted via the first link 331. The size of the data 815 that failed to be transmitted via the second link 332 being less than or equal to (or less than) the size of the data 823 that failed to be transmitted via the first link 331 may indicate that determining the acknowledgement message transmission policy of the first link 331 as the second acknowledgement message transmission mode may implement a higher data rate compared to determining as the first acknowledgement message transmission mode.

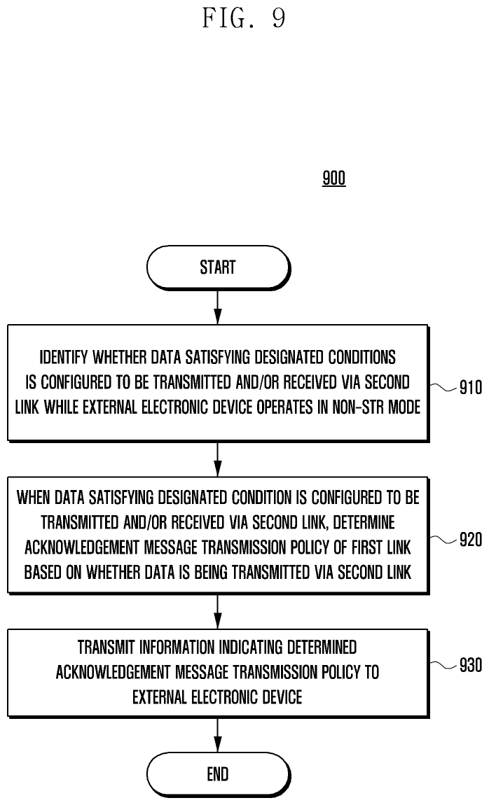

FIG. 9 is an operation flowchart 900 illustrating an operation method of an electronic device according to an embodiment.

In operation 910, the electronic device (e.g., the electronic device 310 of FIG. 5) may identify whether data satisfying designated conditions is configured to be transmitted and/or received via the second link (e.g., the second link 332 of FIG. 3A) while the external electronic device (e.g., the external electronic device 320 of FIG. 3A) is operating in a NSTR mode.

The electronic device 310 may receive, from the external electronic device 320, information indicating that the external electronic device 320 operates in one of the NSTR mode or the STR mode. The information indicating that the external electronic device 320 operates in either the NSTR mode or the STR mode may be received through at least one of the first link 331 and/or the second link 332 established between the electronic device 310 and the external electronic device 320, and may be received via a frame (e.g., a beacon frame or action frame) defined in various methods.

The electronic device 310 may identify whether the external electronic device 320 operates in a NSTR mode, based on the information indicating that the external electronic device 320 operates in either the NSTR mode or the STR mode. A NSTR mode may refer to a mode in which the external electronic device 320 does not receive data via the second link 332 when the external electronic device 320 transmits data to the electronic device 310 via the first link 331.

According to an embodiment, the electronic device 310 may identify whether data satisfying the designated condition is configured to be transmitted to and/or received from the external electronic device 320 via the second link 332 when the external electronic device 320 operates in a NSTR mode, which is a mode in which the external electronic device 320 does not receive data via the second link 332 when the external electronic device 320 transmits data to the electronic device 310 via the first link 331.

In order to identity whether data satisfying the designated condition is configured to be transmitted to and/or received from the external electronic device 320 via the second link 332, the electronic device 310 may refer to mapping data that includes types of data that may be transmitted and/or received via the second link 332.

According to an embodiment, the designated condition may include a condition requiring low latency. According to an embodiment, data satisfying the designated condition may include data associated with services that require low latency. Data that fails to satisfy the designated condition may include data associated with services that can be performed smoothly even at a relatively high delay rate.

According to an embodiment, the designated condition may include a condition in which the priority of the data transmitted and/or received via the second link 332 is higher than the priority of the data transmitted and/or received via the first link 331. The higher priority data may be transmitted and/or received preferentially than the lower priority data.

The type of data may refer to a type of service (TID) as defined in IEEE 802.11. According to an embodiment, the type of data may include a first type (e.g., voice data type (VO) or video data type (VI)) that requires a relatively high transmission rate or low latency (e.g., real-time) and/or a second type (e.g., background (BK) and/or best effort (BE)) that is a type of data that may be performed at a relatively low transmission rate or high latency compared to the first type.

Mapping data refers to data in which a data type and a link are mapped, and data having a specific data type may be data that indicates to perform transmission and/or reception through a specific link. For example, mapping data may refer to TID-to-link mapping data as defined in IEEE 802.11.

Based on the mapping data described above, the electronic device 310 may identify whether data satisfying the designated condition is configured to be transmitted to and/or received from the external electronic device 320 via the second link 332.

In operation 920, when data satisfying the designated condition is configured to be transmitted and/or received via the second link 332, the electronic device 310 may determine an acknowledgement message transmission policy of the first link 331 based on whether the data is being transmitted via the second link 332.

In a case that data satisfying the designated condition is configured to be transmitted to and/or received from the external electronic device 320 via the second link 332 (e.g., Table 2), the electronic device 310 may identify whether data is transmitted to the external electronic device 320 via the second link 332 when transmitting data to the external electronic device 320 via the first link 331. The electronic device 310 may determine an acknowledgement message transmission policy of the first link 331 based on whether data is transmitted to the external electronic device 320 via the second link 332 when transmitting data to the external electronic device 320 via the first link 331.

The acknowledgement message transmission policy may include a first acknowledgement message transmission mode, in which the electronic device (e.g., the external electronic device 320) that has received data transmits an acknowledgement message when the electronic device has completed receiving of the data and has received an acknowledgement message transmission request, which is a message requesting transmission of the acknowledgement message, from the electronic device (e.g., the electronic device 310) that has transmitted the data. The first acknowledgement message transmission mode may be referred to as a delayed block ack message mode, and an acknowledgement message exchanged via the first acknowledgement message transmission mode may be referred to as a delayed block ack.

The acknowledgement message transmission policy may include a second acknowledgement message transmission mode, in which the electronic device (e.g., external electronic device 320) that has received data has completed receiving of the data and then transmits the acknowledgement message after a designated time (e.g., short inter frame space (SIFS)). The second acknowledgement message transmission mode may be referred to as an immediate block ack message mode, and the acknowledgement message exchanged via the second acknowledgement message transmission mode may be referred to as an immediate block ack.

Determining of the acknowledgement message transmission policy of the first link 331 by the electronic device 310 may include selecting one of the first acknowledgement message transmission mode or the second acknowledgement message transmission mode. The acknowledgement message policy of the first link 331 may be determined to minimize the latency of transmitting data satisfying designated conditions via the second link 332. Alternatively, the determination of the acknowledgement message transmission policy of the first link 331 may be determined such that services associated with the data satisfying the designated condition can be performed smoothly via the second link 332.

When data is transmitted to the external electronic device 320 via the first link 331, the electronic device 310 may identify whether data transmission to the external electronic device 320 via the second link 332 is initiated (or data is being transmitted to the external electronic device 320 via the second link 332).

When data is transmitted to the external electronic device 320 via the first link 331, not initiating the transmission of data to the external electronic device 320 via the second link 332 (or not transmitting data to the external electronic device 320 via the second link 332) may indicate that the transmission of the data via the first link 331 is performed before the transmission of the data via the second link 332.

The electronic device 310 may determine (or select) an acknowledgement message transmission policy of the first link 331 as a first acknowledgement message transmission mode, based on identifying that when data is transmitted to the external electronic device 320 via the first link 331, no data is being transmitted to the external electronic device 320 via the second link 332.

Based on determining (or selecting) the acknowledgement message transmission policy of the first link 331 as the first acknowledgement message transmission mode, the electronic device 310 may not receive an acknowledgement message from the external electronic device 320 within a designated time (e.g., SIFS) after the transmission of data via the first link 331 is completed. The external electronic device 320 operating in a NSTR mode may not transmit an acknowledgement message via the first link 331, thereby maintaining data reception via the second link 332. Accordingly, the electronic device 310 may maintain transmission of data satisfying the designated condition via the second link 332 even when transmission of data via the first link 331 is completed, and may reduce the time required to transmit data satisfying the designated condition.

In a case that the electronic device 310 determines the acknowledgement message transmission policy of the first link 331 as a second acknowledgement message transmission mode, the electronic device 310 may receive an acknowledgement message from the external electronic device 320 within a designated time (e.g., SIFS) after the transmission of data via the first link 331 is completed. The external electronic device 320 operating in a NSTR mode should transmit the acknowledgement message via the first link 331 and may not be able to perform the reception of data via the second link 332 due to the transmission of the acknowledgement message via the first link 331. The reception of data through the second link 332 is impossible and thus the latency required to transmit data satisfying the designated condition via the second link 332 may increase. By determining (or selecting) the acknowledgement message transmission policy of the first link 331 as the first acknowledgement message transmission mode, the electronic device 310 may prevent (or suppress) the increase in latency for transmitting data satisfying the designated condition via the second link 332.

The electronic device 310 may, when transmission of data satisfying the designated condition via the second link 332 is completed, transmit an acknowledgement message transmission request message (or signal) to the external electronic device 320 through at least one of the first link 331 and/or the second link 332. Upon receiving the acknowledgement message transmission request message (or signal), the external electronic device 320 may transmit, to the electronic device 310, an acknowledgement message indicating that the reception of the data via the first link 331 is completed and/or an acknowledgement message indicating that the reception of the data via the second link 332 is completed. The external electronic device 320 may also transmit an acknowledgement message (e.g., a multi-STA BA) obtained by combining an acknowledgement message indicating that the reception of data via the first link 331 is completed and/or an acknowledgement message indicating that the reception of the data via the second link 332 is completed.

Based on reception of the acknowledgement message, the electronic device 310 may transmit other data to the external electronic device 320 via the first link 331 and/or the second link 332.

The transmission of data to the external electronic device 320 via the second link 332, which has already been initiated when data is transmitted to the external electronic device 320 via the first link 331, may refer to the transmission of data via the second link 332 being performed before the transmission of data via the first link 331.

The electronic device 310 may determine (or select) an acknowledgement message transmission policy of the first link 331 as a second acknowledgement message transmission mode, based on the identifying that data is being transmitted to the external electronic device 320 via the second link 332 when transmitting data to the external electronic device 320 via the first link 331.

It may be advantageous for the external electronic device 320 operating in a NSTR mode to transmit, within a designated time, an acknowledgement message indicating that the reception of data via the second link 332 is completed in order to reduce latency in the transmission and/or reception of data satisfying designated conditions via the second link 332. Accordingly, the electronic device 310 and/or the external electronic device 320 may determine an acknowledgement message transmission policy of the second link 332 as a second acknowledgement message transmission mode. The electronic device 310 may determine the acknowledgement message transmission policy of the first link 331 as the second acknowledgement message transmission mode to facilitate transmission and/or reception of the acknowledgement message via the second link 332.

Based on determining (or selecting) the acknowledgement message transmission policy of the first link 331 as the second acknowledgement message transmission mode, the electronic device 310 may perform transmission of data via the first link 331. The size of the data transmitted via the first link 331 may be determined based on a time point at which the transmission of the data via the second link 332 is completed. According to an embodiment, the electronic device 310 may determine the size of the data to be transmitted via the first link 331 so that the transmission of the data via the first link 331 is able to be completed by the time point at which the transmission of the data via the second link 332 is completed. In a case that the size of the data is larger than the determined size, the electronic device 310 may split the data and transmit the split data via the first link 331, and the remaining data may be transmitted later via the first link 331.

The electronic device 310 may transmit data via the first link 331 until the transmission of data via the second link 332 is completed. When transmission of data via the second link 332 is completed, the transmission of data via the first link 331 may be suspended in order to wait for reception of an acknowledgement message via the second link 332. The above operation considers the external electronic device 320 operating in a NSTR mode, and the external electronic device 320 operating in the NSTR mode may not be able to transmit data (or an acknowledgement message) via the second link 332 while receiving data via the first link 331. Accordingly, the electronic device 310 may suspend transmission of data via the first link 331 during an interval in which the external electronic device 320 is able to transmit an acknowledgement message via the second link 332.

The electronic device 310 may receive the acknowledgement message within a designated time (e.g., SIFS) after the transmission of data via the first link 331 is completed, based on determining (or selecting) the acknowledgement message transmission policy of the first link 331 as the second acknowledgement message transmission mode.

Alternatively, the electronic device 310 may determine the acknowledgement message transmission policy of the first link 331 to be the same as the acknowledgement message transmission policy of the second link 332, based on identifying that data is being transmitted to the external electronic device 320 via the second link 332 when transmitting data to the external electronic device 320 via the first link 331.

For example, in a case that data is being transmitted to the external electronic device 320 via the second link 332 when transmitting data to the external electronic device 320 via the first link 331 and that the acknowledgement message transmission policy of the second link 332 is the second acknowledgement message transmission mode, the electronic device 310 may determine the acknowledgement message transmission policy of the first link 331 as the second acknowledgement message transmission mode.

In another example, in a case that data is being transmitted to the external electronic device 320 via the second link 332 when transmitting data to the external electronic device 320 via the first link 331 and that the acknowledgement message transmission policy of the second link 332 is the first acknowledgement message transmission mode, the electronic device 310 may determine the acknowledgement message transmission policy of the first link 331 as the first acknowledgement message transmission mode.

In operation 930, the electronic device 310 may transmit, to the external electronic device 320, information indicating the determined acknowledgement message transmission policy.

The electronic device 310 may control the communication circuit 510 to transmit information indicating the determined acknowledgement message transmission policy to the external electronic device 320. Transmitting of the information indicating the determined acknowledgement message transmission policy may be an operation performed during negotiation of the acknowledgement message transmission policy. According to an embodiment, the electronic device 310 may control the communication circuit 510 to transmit, to the external electronic device 320, a negotiation request message (e.g., an ADDBA request frame) that includes information indicating the determined acknowledgement message transmission policy. In a case of receiving a message indicating acceptance of the external electronic device 320 of the determined acknowledgement message transmission policy, the electronic device 310 may transmit and/or receive an acknowledgement message, or transmit and/or receive an acknowledgement message request message in accordance with the determined acknowledgement message transmission policy.

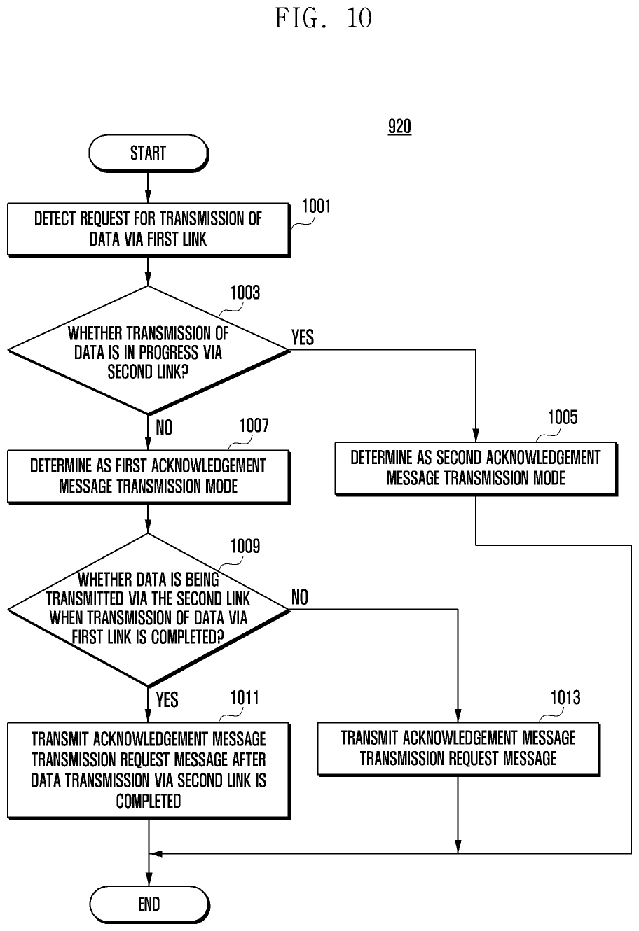

FIG. 10 is an operation flowchart illustrating an operation method of an electronic device according to an embodiment.

FIG. 10 is a flowchart specifically illustrating the operation 920 of determining an acknowledgement message transmission policy of the first link 331 shown in FIG. 9.

Referring to FIG. 10, in operation 1001, the electronic device (e.g., the electronic device 310 of FIG. 5) may detect a request for transmission of data via the first link 331.

According to an embodiment, the electronic device 310 may detect the request for data transmission via the first link 331, based on an application performing a service through near field communication initiating a procedure for data transmission. The electronic device 310 may determine an acknowledgement message transmission policy of the first link 331 to perform data transmission via the first link 331.

In a case that data satisfying the designated condition is configured to be transmitted to and/or received from the external electronic device 320 via the second link 332 (e.g., Table 2), the electronic device 310 may identify whether data is transmitted to the external electronic device 320 via the second link 332 when transmitting data to the external electronic device 320 via the first link 331. The electronic device 310 may determine an acknowledgement message transmission policy of the first link 331 based on whether data is transmitted to the external electronic device 320 via the second link 332 when transmitting data to the external electronic device 320 via the first link 331.

The acknowledgement message transmission policy may include a first acknowledgement message transmission mode, in which the electronic device (e.g., the external electronic device 320) that has received data transmits an acknowledgement message when the electronic device has completed receiving of the data and has received an acknowledgement message transmission request, which is a message requesting transmission of the acknowledgement message, from the electronic device (e.g., the electronic device 310) that has transmitted the data. The first acknowledgement message transmission mode may be referred to as a delayed block ack message mode, and an acknowledgement message exchanged via the first acknowledgement message transmission mode may be referred to as a delayed block ack.

The acknowledgement message transmission policy may include a second acknowledgement message transmission mode, in which the electronic device (e.g., external electronic device 320) that has received data has completed receiving of the data and then transmits the acknowledgement message after a designated time (e.g., short inter frame space (SIFS)). The second acknowledgement message transmission mode may be referred to as an immediate block ack message mode, and the acknowledgement message exchanged via the second acknowledgement message transmission mode may be referred to as an immediate block ack.

Determining of the acknowledgement message transmission policy of the first link 331 by the electronic device 310 may include selecting one of the first acknowledgement message transmission mode or the second acknowledgement message transmission mode. The acknowledgement message policy of the first link 331 may be determined to minimize the latency of transmitting data satisfying designated conditions via the second link 332. Alternatively, the determination of the acknowledgement message transmission policy of the first link 331 may be determined such that services associated with the data satisfying the designated condition can be performed smoothly via the second link 332.

In operation 1003, the electronic device 310 may identify whether the transmission of the data is in progress via the second link 332.

The electronic device 310 may identify whether the electronic device 310 is initiated transmission of data to the external electronic device 320 via the second link 332 when transmitting data to the external electronic device 320 via the first link 331 (or data is being transmitted to the external electronic device 320 via the second link 332).

In operation 1005, based on identifying that the transmission of data via the second link 332 is in progress (“Yes” in operation 1003), the electronic device 310 may determine an acknowledgement message transmission policy of the first link 331 as a second acknowledgement message transmission mode.

The electronic device 310 may determine (or select) an acknowledgement message transmission policy of the first link 331 as a second acknowledgement message transmission mode, based on the identifying that data is being transmitted to the external electronic device 320 via the second link 332 when transmitting data to the external electronic device 320 via the first link 331.

It may be advantageous for the external electronic device 320 operating in a NSTR mode to transmit, within a designated time, an acknowledgement message indicating that the reception of data via the second link 332 is completed in order to reduce latency in the transmission and/or reception of data satisfying designated conditions via the second link 332. Accordingly, the electronic device 310 and/or the external electronic device 320 may determine an acknowledgement message transmission policy of the second link 332 as a second acknowledgement message transmission mode. The electronic device 310 may determine the acknowledgement message transmission policy of the first link 331 as the second acknowledgement message transmission mode to facilitate transmission and/or reception of the acknowledgement message via the second link 332.

Based on determining (or selecting) the acknowledgement message transmission policy of the first link 331 as the second acknowledgement message transmission mode, the electronic device 310 may perform transmission of data via the first link 331. The size of the data transmitted via the first link 331 may be determined based on a time point at which the transmission of the data via the second link 332 is completed. According to an embodiment, the electronic device 310 may determine the size of the data to be transmitted via the first link 331 so that the transmission of the data via the first link 331 is able to be completed by the time point at which the transmission of the data via the second link 332 is completed. In a case that the size of the data is larger than the determined size, the electronic device 310 may split the data and transmit the split data via the first link 331, and the remaining data may be transmitted later via the first link 331.

The electronic device 310 may transmit data via the first link 331 until the transmission of data via the second link 332 is completed. When transmission of data via the second link 332 is completed, the transmission of data via the first link 331 may be suspended in order to wait for reception of an acknowledgement message via the second link 332. The above operation considers the external electronic device 320 operating in a NSTR mode, and the external electronic device 320 operating in the NSTR mode may not be able to transmit data (or an acknowledgement message) via the second link 332 while receiving data via the first link 331. Accordingly, the electronic device 310 may suspend transmission of data via the first link 331 during an interval in which the external electronic device 320 is able to transmit an acknowledgement message via the second link 332.

The electronic device 310 may receive the acknowledgement message within a designated time (e.g., SIFS) after the transmission of data via the first link 331 is completed, based on determining (or selecting) the acknowledgement message transmission policy of the first link 331 as the second acknowledgement message transmission mode.

In operation 1007, based on identifying that no data is being transmitted via the second link 332 (i.e., “No” in operation 1003), the electronic device 310 may determine the acknowledgement message transmission policy of the first link 331 as the first acknowledgement message transmission mode.

When data is transmitted to the external electronic device 320 via the first link 331, not initiating the transmission of data to the external electronic device 320 via the second link 332 (or not transmitting data to the external electronic device 320 via the second link 332) may indicate that the transmission of the data via the first link 331 is performed before the transmission of the data via the second link 332.

The electronic device 310 may determine (or select) an acknowledgement message transmission policy of the first link 331 as a first acknowledgement message transmission mode, based on identifying that when data is transmitted to the external electronic device 320 via the first link 331, no data is being transmitted to the external electronic device 320 via the second link 332.

Based on determining (or selecting) the acknowledgement message transmission policy of the first link 331 as the first acknowledgement message transmission mode, the electronic device 310 may not receive an acknowledgement message from the external electronic device 320 within a designated time (e.g., SIFS) after the transmission of data via the first link 331 is completed. The external electronic device 320 operating in a NSTR mode may not transmit an acknowledgement message via the first link 331, thereby maintaining data reception via the second link 332. Accordingly, the electronic device 310 may maintain transmission of data satisfying the designated condition via the second link 332 even when transmission of data via the first link 331 is completed, and may reduce the time required to transmit data satisfying the designated condition.

In a case that the electronic device 310 determines the acknowledgement message transmission policy of the first link 331 as a second acknowledgement message transmission mode, the electronic device 310 may receive an acknowledgement message from the external electronic device 320 within a designated time (e.g., SIFS) after the transmission of data via the first link 331 is completed. The external electronic device 320 operating in a NSTR mode should transmit the acknowledgement message via the first link 331 and may not be able to perform the reception of data via the second link 332 due to the transmission of the acknowledgement message via the first link 331. The reception of data through the second link 332 is impossible and thus the latency required to transmit data satisfying the designated condition via the second link 332 may increase. By determining (or selecting) the acknowledgement message transmission policy of the first link 331 as the first acknowledgement message transmission mode, the electronic device 310 may prevent (or suppress) the increase in latency for transmitting data satisfying the designated condition via the second link 332.

In operation 1009, the electronic device 310 may identify whether data is being transmitted via the second link 332 when the transmission of data via the first link 331 is completed.

In operation 1011, the electronic device 310 may, based on the data being transmitted via the second link 332 (“Y” in operation 1009) when data transmission via the first link 331 is completed, transmit an acknowledgement message transmission request message to the external electronic device 320 after the data transmission via the second link 332 is completed.

The electronic device 310 may transmit the acknowledgement message transmission request message to the external electronic device 320 after the data transmission via the second link 332 is completed, so that the external electronic device 320 does not interfere with the reception of the data via the second link 332 due to the transmission of the acknowledgement message.

In operation 1013, The electronic device 310 may, based on no data being transmitted via the second link 332 (“N” in operation 1009) when the data transmission via the first link 331 is completed, transmit an acknowledgement message transmission request message to the external electronic device 320.

The electronic device 310 may transmit the acknowledgement message transmission request message to the external electronic device 320, considering that the external electronic device 320 is not receiving data via the second link 332 and accordingly transmission of the acknowledgement message is possible.

An electronic device (e.g., the electronic device 310 of FIG. 3A) according to an embodiment may include a communication circuit (e.g., the communication circuit 510 of FIG. 5) configured to transmit and/or receive data via multiple links including a first link (e.g., the first link 331 of FIG. 3A) and/or a second link (e.g., the second link 332 of FIG. 3A), the multiple links being established between the electronic device 310 and an external electronic device (e.g., the external electronic device 320 of FIG. 3A). The electronic device 310 may include a processor (e.g., the processor 520 of FIG. 5). The electronic device 310 may include a memory (e.g., the memory 530 of FIG. 5). The memory 530 may store instructions which, when executed by the processor 520, cause the electronic device 310 to identify whether data satisfying a predetermined condition is configured to be transmitted to and/or received from the external electronic device 320 via the second link 332 while the external electronic device 320 is operating in a non-simultaneous transmit and receive (NSTR) mode, in which the external electronic device 320 fails to receive data via the second link 332 while transmitting data via the first link 331. The memory 530 may store instructions for, in a case that the data satisfying the predetermined condition is configured to be transmitted to and/or received from the external electronic device 320 via the second link 332, determining an acknowledgement message transmission policy for the first link 331 based on whether data is being transmitted to the external electronic device 320 via the second link 332 when transmitting data to the external electronic device 320 via the first link 331. The memory 530 may store instructions for controlling the communication circuit 510 to transmit information indicating the determined acknowledgement message transmission policy to the external electronic device 320.

In the electronic device 310 according to an embodiment, the memory 530 further stores instructions configured to, based on identifying that data is not being transmitted to the external electronic device 320 via the second link 332 when transmitting data to the external electronic device 320 via the first link 331, configure the acknowledgement message transmission policy of the first link 331 as a first acknowledgement message transmission mode, in which the acknowledgement message is transmitted when receiving a request for transmitting the acknowledgement message.

In the electronic device 310 according to an embodiment, the memory 530 further stores instructions configured to, after completion of the transmission of data via the second link 332, transmit, via the first link 331 and/or the second link 332, a signal requesting for transmitting the acknowledgement message indicating the reception of data via the first link 331 and/or the second link 332.

In the electronic device 310 according to an embodiment, the processor 520 may be configured to receive, via the second link 332, a message obtained by combining an acknowledgement message indicating completion of the transmission of data via the first link 331 and an acknowledgement message indicating completion of the transmission of data via the second link 332.

In the electronic device 310 according to an embodiment, the memory 530 further stores instructions configured to, based on identifying that data is being transmitted to the external electronic device 320 via the second link 332 when transmitting data to the external electronic device 320 via the first link 331, configure the acknowledgement message transmission policy of the first link 331 as a second acknowledgement message transmission mode, in which the acknowledgement message is transmitted within a designated time after completion of the transmission and/or reception of data via the first link 331.

In the electronic device 310 according to an embodiment, the memory 530 further stores instructions configured to transmit data via the first link 331 until a time point at which data transmission via the second link 332 is completed.

In the electronic device 310 according to an embodiment, the memory 530 further stores instructions configured to, in a case that the data satisfying the designated condition is configured to be transmitted to and/or received from the external electronic device 320 via the second link 332, configure an acknowledgement message transmission policy of the second link 332 as a second acknowledgement message transmission mode, in which the acknowledgement message is transmitted within a designated time after completion of the transmission and/or reception of data via the second link 332.

In the electronic device 310 according to an embodiment, the memory 530 further stores instructions configured to, in a case that data not satisfying the designated condition is transmitted to the external electronic device 320 via the second link 332, compare the size of data that failed to be transmitted due to the transmission of the acknowledgement message of the first link, among data to be transmitted via the second link 332, when the acknowledgement message transmission policy of the first link 331 is a second acknowledgement message transmission mode in which the acknowledgement message is transmitted within a designated time after completion of the transmission and/or reception of data via the first link 331, with the size of data that failed to be transmitted via the first link 331 due to data transmission via the second link 332 when the acknowledgement message transmission policy of the first link 331 is a first acknowledgement message transmission mode in which the acknowledgement message is transmitted when receiving a request for transmitting of the acknowledgement message, and determine an acknowledgement message transmission policy of the first link 331 based on a result of the comparison.

In the electronic device 310 according to an embodiment, the designated condition may include a condition requiring low-latency.

In the electronic device 310 according to an embodiment, the designated condition may include a condition in which a priority of data transmitted and/or received via the second link 332 is higher than a priority of data transmitted and/or received via the first link 331.

An operation method of an electronic device 310 according to an embodiment may include an operation of, while an external electronic device 320 for performing communication with the electronic device via a first link 331 and/or a second link 332 operates in a non-simultaneous transmit and receive (NSTR) mode, in which the external electronic device 320 fails to receive data via the second link 332 while transmitting data via the first link 331, identifying whether data satisfying a predetermined condition is configured to be transmitted and/or received via the second link 332 to the external electronic device 320. The operation method of the electronic device 310 may include an operation of, in a case that the data satisfying the predetermined condition is configured to be transmitted to and/or received from the external electronic device 320 via the second link, determining an acknowledgement message transmission policy for the first link 331 based on whether data is being transmitted to the external electronic device 320 via the second link 332 when transmitting data to the external electronic device 320 via the first link 331. The operation method of the electronic device 310 may include an operation of transmitting information indicating the determined acknowledgement message transmission policy to the external electronic device 320.

In the operation method of the electronic device 310 according to an embodiment, the determining of the acknowledgement message transmission policy of the first link 331 may include, based on identifying that data is not being transmitted to the external electronic device 320 via the second link 332 when transmitting data to the external electronic device 320 via the first link 331, determining the acknowledgement message transmission policy of the first link 331 as a first acknowledgement message transmission mode, in which the acknowledgement message is transmitted when receiving a request for transmitting the acknowledgement message.

The operation method of the electronic device 310 according to an embodiment may further include, after completion of the transmission of data via the second link 332, transmitting, via the first link 331 and/or the second link 332, a signal for requesting transmission of the acknowledgement message indicating the reception of data via the first link 331 and/or the second link 332.

The operation method of the electronic device 310 according to an embodiment may further include receiving, via the second link 332, a message obtained by combining an acknowledgement message indicating completion of the transmission of data via the first link 331 and an acknowledgement message indicating completion of the transmission of data via the second link 332.

In the operation method of the electronic device 310 according to an embodiment, the determining of the acknowledgement message transmission policy of the first link 331 may include, based on identifying that data is being transmitted to the external electronic device 320 via the second link 332 when transmitting data to the external electronic device 320 via the first link 331, determining the acknowledgement message transmission policy of the first link 331 as a second acknowledgement message transmission mode, in which the acknowledgement message is transmitted within a designated time after completion of the transmission and/or reception of data via the first link 331.

The operation method of the electronic device 310 according to an embodiment may further include transmitting data via the first link 331 until a time point at which data transmission via the second link 332 is completed.

The operation method of the electronic device 310 according to an embodiment may further include, in a case that the data satisfying the designated condition is configured to be transmitted to and/or received from the external electronic device 320 via the second link 332, configuring an acknowledgement message transmission policy of the second link 332 as a second acknowledgement message transmission mode, in which the acknowledgement message is transmitted within a designated time after completion of receiving data via the second link 332.

The operation method of the electronic device 310 according to an embodiment may further include, in a case that data not satisfying the designated condition is transmitted to the external electronic device 320 via the second link 332, comparing the size of data that failed to be transmitted due to the transmission of the acknowledgement message of the first link, among data to be transmitted via the second link 332, when the acknowledgement message transmission policy of the first link 331 is a second acknowledgement message transmission mode in which the acknowledgement message is transmitted within a designated time after completion of receiving data via the first link 331, with the size of data that failed to be transmitted via the first link 331 due to data transmission via the second link 332 when the acknowledgement message transmission policy of the first link 331 is a first acknowledgement message transmission mode in which the acknowledgement message is transmitted when receiving a request for transmitting of the acknowledgement message, and determining an acknowledgement message transmission policy of the first link 331 based on a result of the comparison.

In the operation method of the electronic device 310 according to an embodiment, the designated condition may include a condition requiring low-latency.

In the operation method of the electronic device 310 according to an embodiment, the designated condition may include a condition in which a priority of data transmitted and/or received via the second link 332 is higher than a priority of data transmitted and/or received via the first link 331.

An electronic device (e.g., the electronic device 310 of FIG. 3A) according to an embodiment may include a communication circuit (e.g., the communication circuit 510 of FIG. 5) configured to transmit and/or receive data via multiple links including a first link (e.g., the first link 331 of FIG. 3A) and/or a second link (e.g., the second link 332 of FIG. 3A), the multiple links being established between the electronic device 310 and an external electronic device (e.g., the external electronic device 320 of FIG. 3A). The electronic device 310 may include a processor (e.g., the processor 520 of FIG. 5). The electronic device 310 may include a memory (e.g., the memory 530 of FIG. 5). The memory 530 may store instructions which, when executed by the processor 520, cause the electronic device to identify whether data satisfying a predetermined condition is configured to be transmitted to and/or received from the external electronic device 320 via the second link 332 while the external electronic device 320 is operating in a non-simultaneous transmit and receive (NSTR) mode, in which the external electronic device 320 fails to receive data via the second link 332 while transmitting data via the first link 331. The memory 530 may store instructions for, in a case that the data satisfying the designated condition is configured to be transmitted to and/or received from the external electronic device 320 via the second link 332, configuring the acknowledgement message transmission policy of the first link 331 as a first acknowledgement message transmission mode, in which the acknowledgement message is transmitted when receiving a request for transmitting the acknowledgement message, based on identifying that data is not transmitted to the external electronic device 320 via the second link 332 when transmitting data to the external electronic device 320 via the first link 331. The memory 530 may store instructions for controlling the communication circuit 510 to transmit information indicating the determined acknowledgement message transmission policy to the external electronic device 320.

In the electronic device 310 according to an embodiment, the memory 530 may further store instructions for, after completion of transmission of data via the second link 332, transmitting, via the second link 332, a signal requesting transmission of the acknowledgement message indicating the reception of data via the first link 331.

In the electronic device 310 according to an embodiment, the processor 520 may be configured to receive, via the second link 332, a message obtained by combining an acknowledgement message indicating completion of the transmission of data via the first link 331 and an acknowledgement message indicating completion of the transmission of data via the second link 332.

In the electronic device 310 according to an embodiment, the designated condition may include a condition requiring low-latency.

In the electronic device 310 according to an embodiment, the designated condition may include a condition in which a priority of data transmitted and/or received via the second link 332 is higher than a priority of data transmitted and/or received via the first link 331.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

1. An electronic device comprising:
a communication circuit configured to transmit or receive data via multiple links including a first link and a second link, the multiple links being established between the electronic device and an external electronic device;
a processor coupled to the communication circuit; and
a memory coupled to the processor, the memory configured to store at least one computer program including instructions,
wherein the instructions, when executed by the processor, cause the electronic device to:
determine whether data satisfying a designated condition is configured to be transmitted to or received from the external electronic device via the second link while the external electronic device is operating in a non-simultaneous transmit and receive (NSTR) mode, in which the external electronic device is not allowed to receive data via the second link while transmitting data via the first link,
in a case that the data satisfying the designated condition is configured to be transmitted to or received from the external electronic device via the second link, determine an acknowledgement message transmission policy of the first link based on whether data is being transmitted to the external electronic device via the second link while transmitting data to the external electronic device via the first link, and
control the communication circuit to transmit information indicating the determined acknowledgement message transmission policy to the external electronic device.

2. The electronic device of claim 1, wherein the instructions, when executed by the processor, cause the electronic device to:
configure the acknowledgement message transmission policy for the first link as a first acknowledgement message transmission mode, wherein the acknowledgement message is transmitted when receiving a request for transmitting the acknowledgement message, based on identifying that data is not being transmitted to the external electronic device via the second link while transmitting data to the external electronic device via the first link.

3. The electronic device of claim 2, wherein the instructions, when executed by the processor, cause the electronic device to:
transmit, via the first link or the second link, a signal for requesting transmission of the acknowledgement message indicating the reception of data via the first link or the second link, after completion of the transmission of data via the second link.

4. The electronic device of claim 2, wherein the instructions, when executed by the processor, cause the electronic device to:
receive, via the second link, a message obtained by combining an acknowledgement message indicating completion of the transmission of data via the first link and an acknowledgement message indicating completion of the transmission of data via the second link.

5. The electronic device of claim 1, wherein the instructions, when executed by the processor, cause the electronic device to:
configure the acknowledgement message transmission policy of the first link as a second acknowledgement message transmission mode, wherein the acknowledgement message is transmitted within a designated time after completion of the transmission or reception of data via the first link, based on identifying that data is being transmitted to the external electronic device via the second link while transmitting data to the external electronic device via the first link.

6. The electronic device of claim 5, wherein the instructions, when executed by the processor, cause the electronic device to:
transmit data via the first link until a time point at which data transmission via the second link is completed.

7. The electronic device of claim 1, wherein the instructions, when executed by the processor, cause the electronic device to:
in a case that the data satisfying the designated condition is configured to be transmitted to or received from the external electronic device via the second link, configure an acknowledgement message transmission policy of the second link as a second acknowledgement message transmission mode, in which the acknowledgement message is transmitted within a designated time after completion of the reception of data via the second link.

8. The electronic device of claim 1, wherein the instructions, when executed by the processor, cause the electronic device to:
in a case that data not satisfying the designated condition is transmitted to the external electronic device via the second link, compare the size of data that failed to be transmitted due to the transmission of the acknowledgement message of the first link, among data to be transmitted via the second link, when the acknowledgement message transmission policy of the first link is a second acknowledgement message transmission mode in which the acknowledgement message is transmitted within a designated time after completion of the transmission or reception of data via the first link, with the size of data that failed to be transmitted via the first link due to data transmission via the second link when the acknowledgement message transmission policy of the first link is a first acknowledgement message transmission mode, in which the acknowledgement message is transmitted when receiving a request for transmitting of the acknowledgement message; and
determine an acknowledgement message transmission policy of the first link based on a result of the comparison.

9. The electronic device of claim 1, wherein the designated condition comprises a condition requiring low-latency.

10. The electronic device of claim 1, wherein the designated condition comprises a condition in which a priority of data transmitted or received via the second link is higher than a priority of data transmitted or received via the first link.

11. An operation method of an electronic device, the operation method comprising:
while an external electronic device for performing communication with the electronic device via a first link or a second link operates in a non-simultaneous transmit and receive (NSTR) mode, in which the external electronic device is not allowed to receive data via the second link while transmitting data via the first link, determining whether data satisfying a designated condition is configured to be transmitted to or received from the external electronic device via the second link;
in a case that the data satisfying the designated condition is configured to be transmitted to or received from external electronic device via the second link, determining an acknowledgement message transmission policy of the first link based on whether data is being transmitted to the external electronic device via the second link while transmitting data to the external electronic device via the first link; and
transmitting information indicating the determined acknowledgement message transmission policy to the external electronic device.

12. The operation method of claim 11, wherein the determining of the acknowledgement message transmission policy of the first link comprises determining the acknowledgement message transmission policy of the first link as a first acknowledgement message transmission mode, wherein the acknowledgement message is transmitted when receiving a request for transmitting the acknowledgement message, based on identifying that data is not being transmitted to the external electronic device via the second link while transmitting data to the external electronic device via the first link.

13. The operation method of claim 12, further comprising transmitting, via the first link or the second link, a signal for requesting transmission of the acknowledgement message indicating the reception of data via the first link or the second link, after completion of the transmission of data via the second link.

14. The operation method of claim 12, further comprising receiving, via the second link, a message obtained by combining an acknowledgement message indicating completion of the transmission of data via the first link and an acknowledgement message indicating completion of the transmission of data via the second link.

15. The operation method of claim 11, wherein the determining of the acknowledgement message transmission policy of the first link comprises determining the acknowledgement message transmission policy of the first link as a second acknowledgement message transmission mode, wherein the acknowledgement message is transmitted within a designated time after completion of the transmission or reception of data via the first link, based on identifying that data is being transmitted to the external electronic device via the second link when transmitting data to the external electronic device via the first link.

16. The operation method of claim 15, further comprising transmitting data via the first link until a time point at which data transmission via the second link is completed.

17. The operation method of claim 11, further comprising, in a case that the data satisfying the designated condition is configured to be transmitted to or received from the external electronic device via the second link, configuring an acknowledgement message transmission policy of the second link as a second acknowledgement message transmission mode, wherein the acknowledgement message is transmitted within a designated time after completion of the reception of data via the second link.

18. The operation method of claim 11, further comprising:
in a case that data not satisfying the designated condition is transmitted to the external electronic device via the second link, comparing a size of data that failed to be transmitted due to the transmission of the acknowledgement message of the first link, among data to be transmitted via the second link, when the acknowledgement message transmission policy of the first link is a second acknowledgement message transmission mode, wherein the acknowledgement message is transmitted within a designated time after completion of the reception of data via the first link, with the size of data that failed to be transmitted via the first link due to data transmission via the second link when the acknowledgement message transmission policy of the first link is a first acknowledgement message transmission mode, wherein the acknowledgement message is transmitted when receiving a request for transmitting of the acknowledgement message; and
determining an acknowledgement message transmission policy of the first link based on a result of the comparison.

19. The operation method of claim 11, wherein the designated condition requires low latency.

20. The operation method of claim 11, wherein the designated condition requires that a priority of data transmitted or received via the second link is higher than a priority of data transmitted or received via the first link.
